(19) United States
(12) Patent Application Publication
(10) Pub. No.: US 2026/0113812 A1
(43) Pub. Date: Apr. 23, 2026

(54) INDEPENDENTLY-CONTROLLED DOUBLE EARTHING MAT WITH REDUCED POWER CONSUMPTION

(71) Applicant: EMAG Innovation Co., Ltd., Gwangju-si (KR)

(72) Inventors: Seung Hyeon YI, Jeollanam-do (KR); Byoung Sun LEE, Chuncheon-si (KR)

(73) Assignee: EMAG Innovation Co., Ltd., Gwangju-si (KR)

(21) Appl. No.: 19/424,867

(22) Filed: Dec. 18, 2025

Related U.S. Application Data
(63) Continuation of application No. PCT/KR2023/008616, filed on Jun. 21, 2023.

(51) Int. Cl. H05B 1/02; A47C 21/04; A47C 31/00; H05B 3/00; H05B 3/02; H05B 3/56

(52) U.S. Cl. CPC H05B 1/0272; A47C 21/048; A47C 31/004; H05B 3/0019; H05B 3/02; H05B 3/56; H05B 2203/003; H05B 2203/005

(57) ABSTRACT

A double earthing mat is provided. The double earthing mat comprises: a first mat including a first main body, which has a first heating wire disposed therein, and a first controller, which controls the heating level of the first heating wire; and a second mat including a second main body, which has a second heating wire disposed therein, and a second controller, which controls the heating level of the second heating wire.

### CROSS-REFERENCE TO RELATED APPLICATIONS

This is a continuation of International Patent Application PCT/KR2023/008616 (filed 21 Jun. 2023), the entire disclosure of which is hereby incorporated by reference herein.

### TECHNICAL FIELD

The present invention relates to a double earthing mat, and more particularly, to an independently-controlled double earthing mat with reduced power consumption, in which the double earthing mat includes a first mat including a first main body in which a first heating wire is disposed and a first controller for controlling a heating level of the first heating wire, and a second mat including a second main body in which a second heating wire is disposed and a second controller for controlling a heating level of the second heating wire, which are formed integrally with each other, and the first mat and the second mat are controlled independently of each other.

### BACKGROUND ART

Earthing refers to connecting a portion of an electric device to the ground by a conducting wire to maintain a potential of the device at 0, which is equal to a potential of the ground, and the earthing is also referred to as earth or grounding. When the earthing is performed, in addition to the electric device, static electricity inside a human body may be discharged so as to maintain a potential of a person at 0.

In general, static electricity is generated from a human body for various reasons. When the static electricity is accumulated in the body due to various invisible electromagnetic waves therearound or other factors, the static electricity may cause discomfort and reduce resistance to disease so as to cause various inflammations and pain and make a sound sleep difficult, thereby contributing to various diseases.

Meanwhile, outdoors, in order to perform grounding for the static electricity generated in the human body, exercises such as barefoot walking may be used to set a potential of the human body, which has been increased by electromagnetic waves, environments, or the like, to 0 through soles of feet and the ground. Conversely, indoors, the potential inside the human body may be set to 0 through a carpet, a mat, an electric blanket, and the like with which a floor is covered. In particular, since electric blankets are widely used during winter when outdoor activities are difficult, an earthing mat in which a heating wire is included has been proposed.

However, the heating wire disposed inside a mat of an electric blanket and the like may generate electromagnetic waves, which are harmful to the human body, together with static electricity and the like. In addition, according to the conventional earthing mat in which the heating wire is included, a user may be directly exposed to the electromagnetic waves, and when the earthing mat is folded for storage, the user may be exposed to accidents such as separation or short circuit of the heating wire. Furthermore, in a case of a double earthing mat that allows a plurality of users to control each of mats by one controller, since one controller is connected to the double earthing mat, a length of a heating wire disposed in the mat may be increased, which increases power consumption.

### DISCLOSURE

### Technical Problem

One technical object of the present invention is to provide a double earthing mat capable of controlling a first mat and a second mat, which are formed integrally with each other, independently of each other.

Another technical object of the present invention is to provide a double earthing mat with reduced power consumption.

Still another technical object of the present invention is to provide a double earthing mat with reduced fire risk.

Yet another technical object of the present invention is to provide a washable double earthing mat.

Still yet another technical object of the present invention is to provide a double earthing mat with improved safety.

### Technical Solution

To achieve the technical objects described above, the present invention provides an independently-controlled double earthing mat with reduced power consumption.

According to one embodiment, the double earthing mat in which a first mat and a second mat are formed integrally with each other includes: the first mat including a first main body in which a first heating wire is disposed, and a first controller electrically connected to the first heating wire, and configured to control a heating level of the first heating wire; and the second mat including a second main body in which a second heating wire is disposed, and a second controller electrically connected to the second heating wire, and configured to control a heating level of the second heating wire and operate independently of the first controller.

According to one embodiment, the first main body may include: a first-first side surface, which is a long side surface of the first main body; a first-second side surface, which is a short side surface of the first main body perpendicular to the first-first side surface; and a first-third side surface, which is a short side surface of the first main body opposite to the first-second side surface, the second main body may include: a second-first side surface, which is a long side surface of the second main body opposite to the first-first side surface; a second-second side surface, which is a short side surface of the second main body extending from the first-second side surface; and a second-third side surface, which is a short side surface of the second main body extending from the first-third side surface, and a folding part that is bent so as to allow the first main body and the second main body to overlap each other may be included between the first main body and the second main body.

According to one embodiment, the first controller may be coupled onto the first-first side surface that is adjacent to the first-second side surface, the second controller may be coupled onto the second-first side surface that is adjacent to the second-second side surface, one end and an opposite end of the first heating wire may be electrically connected to the first controller, and one end and an opposite end of the second heating wire may be electrically connected to the second controller.

According to one embodiment, the first heating wire may include: a first-first heating wire part having one end connected to the first controller, and extending parallel to the first-second side surface in a first direction toward the folding part from the first-first side surface; a first-second heating wire part connected to an opposite end of the first-first heating wire part, parallel to the first-first side surface, and extending in a second direction toward the first-third side surface from the first-second side surface; a plurality of first-third heating wire parts extending in the first direction, and spaced apart from each other in the second direction; and a plurality of first-fourth heating wire parts, in which each of the first-fourth heating wire parts connects one end and an opposite end of adjacent first-third heating wire parts, the first-third heating wire part may include: a lowermost first-third heating wire part having one end connected to an opposite end of the first-second heating wire part, and disposed closest to the first-third side surface; an uppermost first-third heating wire part having one end electrically connected to the first controller, and disposed closest to the first-first heating wire part; and an intermediate first-third heating wire part disposed between the lowermost first-third heating wire part and the uppermost first-third heating wire part, the first-fourth heating wire part may connect an opposite end of the lowermost first-third heating wire part to one end of the intermediate first-third heating wire part, and may connect an opposite end of the intermediate first-third heating wire part to an opposite end of the uppermost first-third heating wire part, a plurality of intermediate first-third heating wire parts may be provided, the first-fourth heating wire part may connect one end of the intermediate first-third heating wire part to an opposite end of an adjacent intermediate first-third heating wire part, and the first-first heating wire part, the first-second heating wire part, the first-third heating wire part, and the first-fourth heating wire part may be arranged so as not to overlap each other.

According to one embodiment, the second heating wire may include: a second-first heating wire part having one end connected to the second controller, extending parallel to the second-second side surface in a direction that is antiparallel to the first direction from the second-first side surface, and provided in a shape that is mirror-symmetrical with the first-first heating wire part based on the folding part; a second-second heating wire part connected to an opposite end of the second-first heating wire part, parallel to the second-first side surface, extending in the second direction, and provided in a shape that is mirror-symmetrical with the first-second heating wire part based on the folding part; a plurality of second-third heating wire parts extending in the first direction, spaced apart from each other in the second direction, and provided in a shape that is mirror-symmetrical with the first-third heating wire parts based on the folding part; and a plurality of second-fourth heating wire parts, in which each of the second-fourth heating wire parts connects one end and an opposite end of adjacent second-third heating wire parts, and the second-fourth heating wire parts are provided in a shape that is mirror-symmetrical with the first-fourth heating wire parts based on the folding part.

According to one embodiment, the first heating wire and the second heating wire may not traverse the folding part.

### Advantageous Effects

According to an embodiment of the present invention, the double earthing mat in which a first mat and a second mat are formed integrally with each other may include: the first mat including a first main body in which a first heating wire is disposed, and a first controller electrically connected to the first heating wire, and configured to control a heating level of the first heating wire; and the second mat including a second main body in which a second heating wire is disposed, and a second controller electrically connected to the second heating wire, and configured to control a heating level of the second heating wire and operate independently of the first controller. Accordingly, the first mat and the second mat, which are formed integrally with each other, can be controlled independently of each other, so that convenience of a user can be improved.

In addition, according to an embodiment of the present invention, the first heating wire may include: a first-first heating wire part having one end connected to the first controller, and extending parallel to the first-second side surface in a first direction toward the folding part from the first-first side surface; a first-second heating wire part connected to an opposite end of the first-first heating wire part, parallel to the first-first side surface, and extending in a second direction toward the first-third side surface from the first-second side surface; a plurality of first-third heating wire parts extending in the first direction, and spaced apart from each other in the second direction; and a plurality of first-fourth heating wire parts, in which each of the first-fourth heating wire parts connects one end and an opposite end of adjacent first-third heating wire parts, the first-third heating wire part may include: a lowermost first-third heating wire part having one end connected to an opposite end of the first-second heating wire part, and disposed closest to the first-third side surface; an uppermost first-third heating wire part having one end electrically connected to the first controller, and disposed closest to the first-first heating wire part; and an intermediate first-third heating wire part disposed between the lowermost first-third heating wire part and the uppermost first-third heating wire part, the first-fourth heating wire part may connect an opposite end of the lowermost first-third heating wire part to one end of the intermediate first-third heating wire part, and may connect an opposite end of the intermediate first-third heating wire part to an opposite end of the uppermost first-third heating wire part, a plurality of intermediate first-third heating wire parts may be provided, the first-fourth heating wire part may connect one end of the intermediate first-third heating wire part to an opposite end of an adjacent intermediate first-third heating wire part, the first-first heating wire part, the first-second heating wire part, the first-third heating wire part, and the first-fourth heating wire part may be arranged so as not to overlap each other,
the second heating wire may include: a second-first heating wire part having one end connected to the second controller, extending parallel to the second-second side surface in a direction that is antiparallel to the first direction from the second-first side surface, and provided in a shape that is mirror-symmetrical with the first-first heating wire part based on the folding part; a second-second heating wire part connected to an opposite end of the second-first heating wire part, parallel to the second-first side surface, extending in the second direction, and provided in a shape that is mirror-symmetrical with the first-second heating wire part based on the folding part; a plurality of second-third heating wire parts extending in the first direction, spaced apart from each other in the second direction, and provided in a shape that is mirror-symmetrical with the first-third heating wire parts based on the folding part; and a plurality of second-fourth heating wire parts, in which each of the second-fourth heating wire parts connects one end and an opposite end of adjacent second-third heating wire parts, and the second-fourth heating wire parts are provided in a shape that is mirror-symmetrical with the first-fourth heating wire parts based on the folding part, so that power consumption can be reduced.

In addition, according to an embodiment of the present invention, the first heating wire and the second heating wire may not traverse the folding part, so that fire risk can be reduced, and thus stability can be improved.

### DESCRIPTION OF DRAWINGS

FIGS. 1 and 2 are views for describing a double earthing mat according to an embodiment of the present invention.

FIG. 3 is a sectional view for describing a stacked structure of the double earthing mat according to the embodiment of the present invention.

FIGS. 4 and 5 are views for describing a first heating wire and a second heating wire of the double earthing mat according to the embodiment of the present invention.

FIG. 6 is a view for describing an energy conversion unit of the double earthing mat according to the embodiment of the present invention.

FIGS. 7 and 8 are views for describing a first heating wire and a second heating wire of a double earthing mat according to a first modified example of the present invention.

FIGS. 9 and 10 are views for describing a first heating wire and a second heating wire of a double earthing mat according to a second modified example of the present invention.

FIGS. 11 and 12 are views for describing a first heating wire and a second heating wire of a double earthing mat according to a third modified example of the present invention.

FIG. 13 is a view for describing a first heating wire and a second heating wire of a double earthing mat according to a fourth modified example of the present invention.

FIG. 14 is a view for describing a first heating wire and a second heating wire of a double earthing mat according to a fifth modified example of the present invention.

FIG. 15 is a view for describing a first heating wire and a second heating wire of a double earthing mat according to a sixth modified example of the present invention.

FIG. 16 is a view for describing a first heating wire and a second heating wire of a double earthing mat according to a seventh modified example of the present invention.

FIG. 17 is a view for describing a first heating wire and a second heating wire of a double earthing mat according to an eighth modified example of the present invention.

FIG. 18 is a view for describing a controller for a double earthing mat according to a ninth modified example of the present invention.

FIG. 19 is a view for describing a controller for a double earthing mat according to a 10th modified example of the present invention.

FIG. 20 is a view for describing a single earthing mat according to an 11th modified example of the present invention.

### MODE FOR INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. Further, in the following description of the present invention, detailed descriptions of known functions or configurations incorporated herein will be omitted when they may make the gist of the present invention unnecessarily unclear.

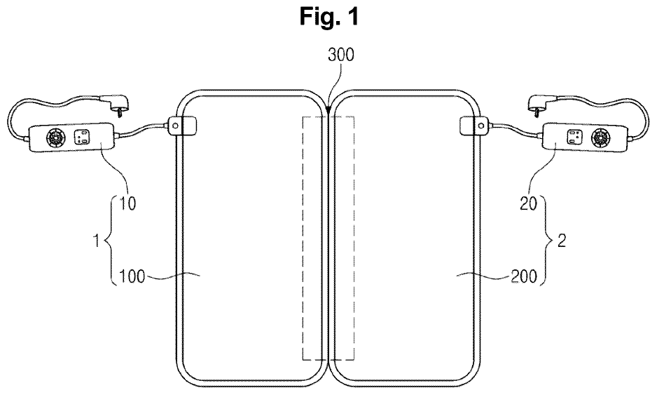

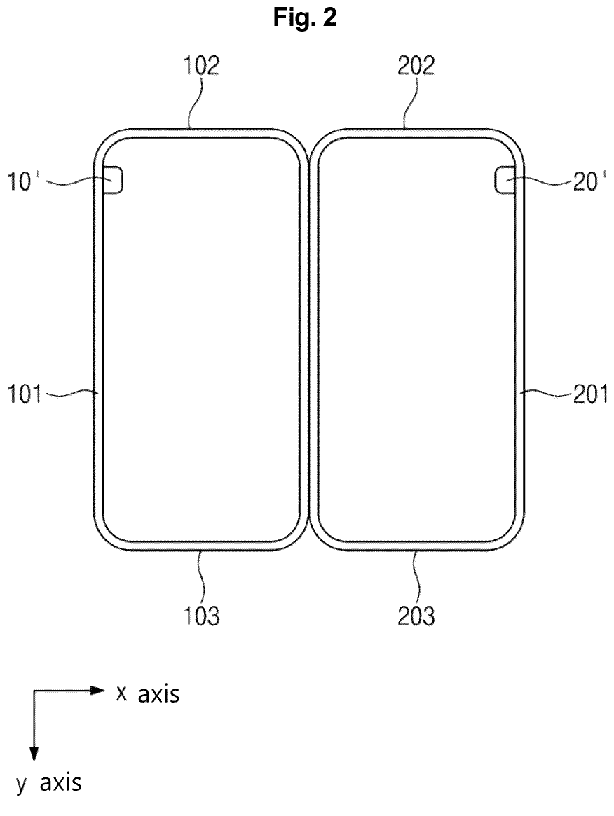

FIGS. 1 and 2 are views for describing a double earthing mat according to an embodiment of the present invention.

Referring to FIGS. 1 and 2, according to a double earthing mat of an embodiment of the present invention, a first mat 1 and a second mat 2 may be formed integrally with each other. The double earthing mat may include a top surface making contact with a lying user, and a plate having a thickness with respect to the top surface. According to the double earthing mat, a folding part 300 that is bent so as to allow the first mat 1 and the second mat 2 to overlap each other may be provided between the first mat 1 and the second mat 2.

The first mat 1 may include a first main body 100 and a first controller 10.

The first main body 100 may be electrically connected to the first controller 10 through a first terminal 10′. The first main body 100 may include a first-first side surface 101, a first-second side surface 102, and a first-third side surface 103, which surround the top surface making contact with the user.

The first-first side surface 101 may be defined as a long side surface, which is a side surface of the first main body 100 having a relatively long length. The first-first side surface 101 may include a side surface that is perpendicular to the top surface making contact with the user.

The first-second side surface 102 may be defined as a short side surface, which is a side surface of the first main body 100 having a relatively short length. The first-second side surface 102 may include a side surface that is perpendicular to the top surface making contact with the user. For example, the first-second side surface 102 may include a side surface in a direction that is adjacent to a head of the user when the user is lying down.

The first-third side surface 103 may be defined as a short side surface, which is a side surface of the first main body 100 having a relatively short length. The first-third side surface 103 may include a side surface that is perpendicular to the top surface making contact with the user. For example, the first-third side surface 103 may include a side surface in a direction that is adjacent to a leg of the user when the user is lying down.

The first controller 10 may be electrically connected to the first main body 100 so as to control a heating level of the first main body 100. The first controller 10 may be coupled onto the first-first side surface 101 that is adjacent to the first-second side surface 102. The first controller 10 may include a dial for controlling the heating level of the first main body 100, a power button, and an LED for checking electromagnetic waves.

The second mat 2 may include a second main body 200 and a second controller 20.

The second main body 200 may be electrically connected to the second controller 20 through a second terminal 20′. The second main body 200 may include a second-first side surface 201, a second-second side surface 202, and a second-third side surface 203, which surround the top surface making contact with the user.

The second-first side surface 201 may be defined as a long side surface, which is a side surface of the second main body 200 having a relatively long length. The second-first side surface 201 may include a side surface that is perpendicular to the top surface making contact with the user.

The second-second side surface 202 may be defined as a short side surface, which is a side surface of the second main body 200 having a relatively short length. The second-second side surface 202 may include a side surface that is perpendicular to the top surface making contact with the user. For example, the second-second side surface 202 may include a side surface in the direction that is adjacent to the head of the user when the user is lying down. The second-second side surface 202 may extend from the first-second side surface 102 of the first main body 100.

The second-third side surface 203 may be defined as a short side surface, which is a side surface of the second main body 200 having a relatively short length. The second-third side surface 203 may include a side surface that is perpendicular to the top surface making contact with the user. For example, the second-third side surface 203 may include a side surface in the direction that is adjacent to the leg of the user when the user is lying down. The second-third side surface 203 may extend from the first-third side surface 103 of the first main body 100.

The second controller 20 may be electrically connected to the second main body 200 so as to control a heating level of the second main body 200. The second controller 20 may be coupled onto the second-first side surface 201 that is adjacent to the second-second side surface 202. The second controller 20 may include a dial for controlling the heating level of the second main body 200, a power button, and an LED for checking electromagnetic waves.

In other words, although the first mat 1 and the second mat 2 are formed integrally with each other, the first mat 1 and the second mat 2 may be controlled independently of each other. That is, the first mat 1 may be controlled by adjusting the heating level of the first main body 100 through the first controller 10, and the second mat 2 may be controlled by adjusting the heating level of the second main body 200 through the second controller 20.

As a result, the first main body 100 and the second main body 200, which are formed integrally with each other, may be controlled independently of each other through the first controller 10 and the second controller 20, which are configured independently of each other, respectively. Accordingly, users lying on the first main body 100 and the second main body 200 may select and adjust desired heating levels, respectively, so that convenience of the user may be improved.

In addition, since the first controller 10 and the second controller 20 are coupled at positions that are adjacent to the first main body 100 and the second main body 200, respectively, lengths of heating wires disposed inside the first main body 100 and the second main body 200 may be minimized, so that power consumption may be reduced.

Furthermore, when specifications of the first controller 10 and the second controller 20 are unified, the controllers 10 and 20 may be universally used for a single earthing mat in which a first mat or a second mat is independently configured as well as the double earthing mat. Accordingly, use convenience of the user may be improved, and a time and a cost for manufacturing the controller may also be reduced.

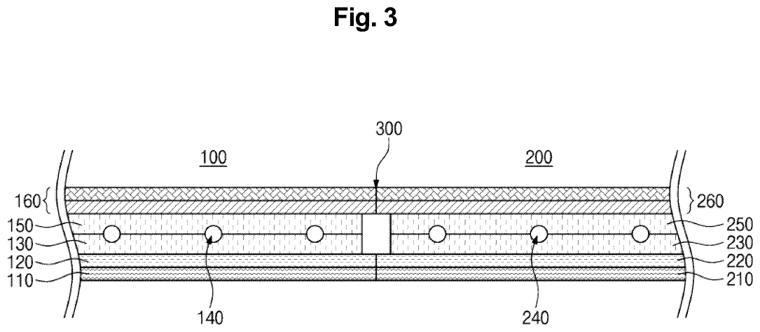

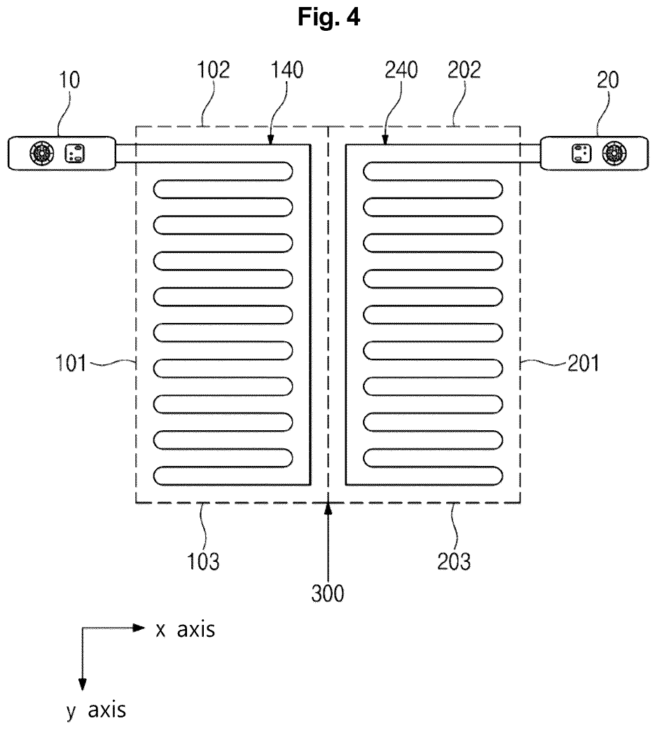

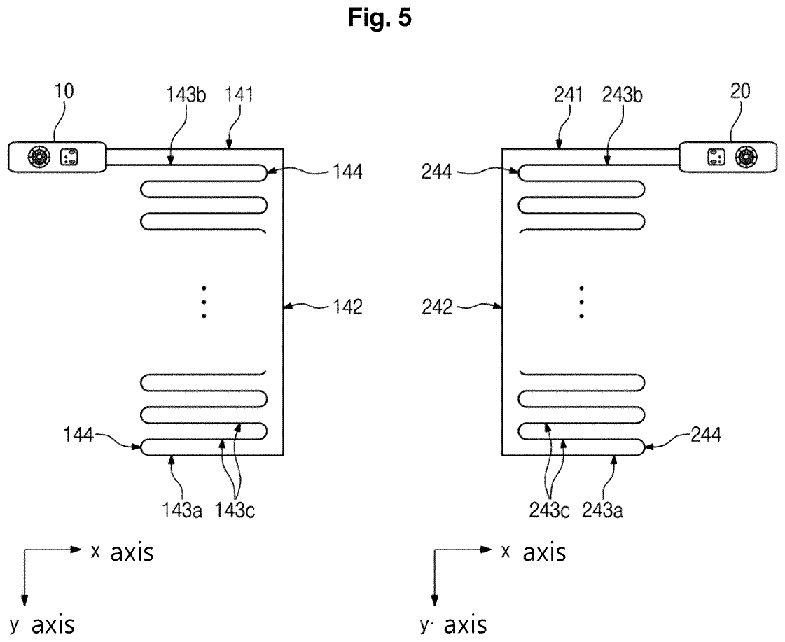

FIG. 3 is a sectional view for describing a stacked structure of the double earthing mat according to the embodiment of the present invention, and FIGS. 4 and 5 are views for describing a first heating wire and a second heating wire of the double earthing mat according to the embodiment of the present invention.

Referring to FIGS. 3 to 5, according to the double earthing mat of the embodiment of the present invention, as described above, the first main body 100 and the second main body 200 may be formed integrally with each other.

The first main body 100 may be formed by sequentially stacking an anti-slip fabric 110, a base fabric 120, a first bottom fabric 130, a first heating wire 140, a first top fabric 150, and an exterior fabric 160.

The anti-slip fabric 110 may include a surface having a frictional force to prevent the first main body 100 from slipping on a floor surface making contact with the first main body 100.

The base fabric 120 may be stacked on the anti-slip fabric 110. The base fabric 120 may absorb an impact transmitted to the user from the floor surface. For example, the base fabric 120 may include a sponge.

The first bottom fabric 130 may be stacked on the base fabric 120. For example, the first bottom fabric 130 may include a non-woven fabric.

The first heating wire 140 may be fixed between the first bottom fabric 130 and the first top fabric 150, which will be described below, through high-frequency bonding. A current may flow inside the first heating wire 140 so that the first heating wire 140 may generate heat. One end and an opposite end of the first heating wire 140 may be electrically connected to the first controller 10. The first heating wire 140 may include a first-first heating wire part 141, a first-second heating wire part 142, a first-third heating wire part 143, and a first-fourth heating wire part 144.

One end of the first-first heating wire part 141 may be electrically connected to the first controller 10. An opposite end of the first-first heating wire part 141 may be connected to the first-second heating wire part 142 that will be described below. The first-first heating wire part 141 may extend parallel to the first-second side surface 102 in a first direction (x-axis direction) toward the folding part 300 from the first-first side surface 101.

One end of the first-second heating wire part 142 may be connected to the opposite end of the first-first heating wire part 141. An opposite end of the first-second heating wire part 142 may be connected to the first-third heating wire part 143 that will be described below. The first-second heating wire part 142 may be parallel to the first-first side surface 101, and may extend in a second direction (y-axis direction) toward the first-third side surface 103 from the first-second side surface 102.

A plurality of first-third heating wire parts 143 may extend in the first direction (x-axis direction), and may be spaced apart from each other in the second direction (y-axis direction). The first-third heating wire part 143 may include a lowermost first-third heating wire part 143a, an uppermost first-third heating wire part 143b, and an intermediate first-third heating wire part 143c.

One end of the lowermost first-third heating wire part 143a may be connected to the opposite end of the first-second heating wire part 142. An opposite end of the lowermost first-third heating wire part 143a may be connected to one end of the intermediate first-third heating wire part 143c. The lowermost first-third heating wire part 143a may be disposed closest to the first-third side surface 103 among the first-third heating wire parts 143.

One end of the uppermost first-third heating wire part 143b may be electrically connected to the first controller 10. An opposite end of the uppermost first-third heating wire part 143b may be connected to an opposite end of the intermediate first-third heating wire part 143c. The uppermost first-third heating wire part 143b may be disposed closest to the first-first heating wire part 141 among the first-third heating wire parts 143.

The intermediate first-third heating wire part 143c may be disposed between the lowermost first-third heating wire part 143a and the uppermost first-third heating wire part 143b. As described above, the one end of the intermediate first-third heating wire part 143c may be connected to the opposite end of the lowermost first-third heating wire part 143a, and the opposite end of the intermediate first-third heating wire part 143c may be connected to the opposite end of the uppermost first-third heating wire part 143b. According to one embodiment, a plurality of intermediate first-third heating wire parts 143c may be provided.

The first-fourth heating wire part 144 may connect one end and an opposite end of adjacent first-third heating wire parts 143. The first-fourth heating wire part 144 may connect the opposite end of the lowermost first-third heating wire part 143a to the one end of the intermediate first-third heating wire part 143c, and may connect the opposite end of the intermediate first-third heating wire part 143c to the opposite end of the uppermost first-third heating wire part 143b. When a plurality of intermediate first-third heating wire parts 143c are provided, the first-fourth heating wire part 144 may connect one end of the intermediate first-third heating wire part 143c to an opposite end of an adjacent intermediate first-third heating wire part 143c. For example, the first-fourth heating wire part 144 may include a semicircular arc shape as shown in the drawings.

As a result, the first-first heating wire part 141, the first-second heating wire part 142, the first-third heating wire part 143, and the first-fourth heating wire part 144 may be arranged so as not to overlap each other. In addition, the first-second heating wire part 142 that is parallel to the folding part 300 may be disposed closest to the folding part 300, so that even when the first main body 100 overlaps the second main body 200 through the folding part 300, the first heating wire 140 may not traverse the folding part 300, and thus stability may be further improved.

The first top fabric 150 may be stacked on the first heating wire 140. For example, the first top fabric 150 may include a non-woven fabric.

In other words, the first heating wire 140 may be bonded while being surrounded by the first bottom fabric 130 and the first top fabric 150 without being simply stacked between the first bottom fabric 130 and the first top fabric 150. That is, a space between the first bottom fabric 130 and the first top fabric 150 may be minimized, and the first heating wire 140 may be fixed to the first bottom fabric 130 and the first top fabric 150. Accordingly, the first heating wire 140 may be prevented from being separated from the first bottom fabric 130 and the first top fabric 150, washability may be achieved, and a possibility of an accident such as fire may be reduced.

The exterior fabric 160 may be stacked on the first top fabric 150. The exterior fabric 160 may include a pattern on the top surface making contact with the user. For example, the exterior fabric 160 may include a floor paper pattern, a wood section pattern, a marble pattern, and the like, but is not limited thereto.

Similar to the first main body 100, the second main body 200 may be formed by sequentially stacking an anti-slip fabric 210, a base fabric 220, a second bottom fabric 230, a second heating wire 240, a second top fabric 250, and an exterior fabric 260.

The anti-slip fabric 210 may include a surface having a frictional force to prevent the second main body 200 from slipping on the floor surface making contact with the second main body 200. The anti-slip fabric 210 of the second main body 200 may be formed integrally with the anti-slip fabric 110 of the first main body 100.

The base fabric 220 may be stacked on the anti-slip fabric 210. The base fabric 220 may absorb an impact transmitted to the user from the floor surface. The base fabric 220 of the second main body 200 may be formed integrally with the base fabric 120 of the first main body 100. Similarly, the base fabric 220 of the second main body 200 may include a sponge.

The second bottom fabric 230 may be stacked on the base fabric 220. For example, the second bottom fabric 230 may include a non-woven fabric.

The second heating wire 240 may be fixed between the second bottom fabric 230 and the second top fabric 250, which will be described below, through high-frequency bonding. A current may flow inside the second heating wire 240 so that the second heating wire 240 may generate heat. One end and an opposite end of the second heating wire 240 may be electrically connected to the second controller 20. The second heating wire 240 may include a second-first heating wire part 241, a second-second heating wire part 242, a second-third heating wire part 243, and a second-fourth heating wire part 244.

One end of the second-first heating wire part 241 may be electrically connected to the second controller 20. An opposite end of the second-first heating wire part 241 may be connected to the second-second heating wire part 242 that will be described below. The second-first heating wire part 241 may extend parallel to the second-second side surface 202 in a direction ((−x)-axis direction) that is antiparallel to the first direction (x-axis direction). The second-first heating wire part 241 may be provided in a shape that is mirror-symmetrical with the first-first heating wire part 141 based on the folding part 300.

One end of the second-second heating wire part 242 may be connected to the opposite end of the second-first heating wire part 241. An opposite end of the second-second heating wire part 242 may be connected to the second-third heating wire part 243 that will be described below. The second-second heating wire part 242 may be parallel to the second-first side surface 201, and may extend in the second direction (y-axis direction). The second-second heating wire part 242 may be provided in a shape that is mirror-symmetrical with the first-second heating wire part 142 based on the folding part 300.

A plurality of second-third heating wire parts 243 may extend in the first direction (x-axis direction), and may be spaced apart from each other in the second direction (y-axis direction). The second-third heating wire part 243 may include a lowermost second-third heating wire part 243a, an uppermost second-third heating wire part 243b, and an intermediate second-third heating wire part 243c. The second-third heating wire parts 243 may be provided in a shape that is mirror-symmetrical with the first-third heating wire parts 143 based on the folding part 300.

One end of the lowermost second-third heating wire part 243a may be connected to the opposite end of the second-second heating wire part 242. An opposite end of the lowermost second-third heating wire part 243a may be connected to one end of the intermediate second-third heating wire part 243c that will be described below. The lowermost second-third heating wire part 243a may be disposed closest to the second-third side surface 203 among the second-third heating wire parts 243.

One end of the uppermost second-third heating wire part 243b may be electrically connected to the second controller 20. An opposite end of the uppermost second-third heating wire part 243b may be connected to an opposite end of the intermediate second-third heating wire part 243c. The uppermost second-third heating wire part 243b may be disposed closest to the second-first heating wire part 241 among the second-third heating wire parts 243.

The intermediate second-third heating wire part 243c may be disposed between the lowermost second-third heating wire part 243a and the uppermost second-third heating wire part 243b. As described above, the one end of the intermediate second-third heating wire part 243c may be connected to the opposite end of the lowermost second-third heating wire part 243a, and the opposite end of the intermediate second-third heating wire part 243c may be connected to the opposite end of the uppermost second-third heating wire part 243b. According to one embodiment, a plurality of intermediate second-third heating wire parts 243c may be provided.

The second-fourth heating wire part 244 may connect one end and an opposite end of adjacent second-third heating wire parts 243. The second-fourth heating wire part 244 may connect the opposite end of the lowermost second-third heating wire part 243a to the one end of the intermediate second-third heating wire part 243c, and may connect the opposite end of the intermediate second-third heating wire part 243c to the opposite end of the uppermost second-third heating wire part 243b. When a plurality of intermediate second-third heating wire parts 243c are provided, the second-fourth heating wire part 244 may connect one end of the intermediate second-third heating wire part 243c to an opposite end of an adjacent intermediate second-third heating wire part 243c. For example, the second-fourth heating wire part 244 may include a semicircular arc shape as shown in the drawings.

In other words, the second-first heating wire part 241, the second-second heating wire part 242, the second-third heating wire part 243, and the second-fourth heating wire part 244 may be arranged so as not to overlap each other. In addition, the second-second heating wire part 242 that is parallel to the folding part 300 may be disposed closest to the folding part 300, so that even when the second main body 200 overlaps the first main body 100 through the folding part 300, the second heating wire 240 may not traverse the folding part 300, and thus stability may be further improved.

As a result, the first-first heating wire part 141, the first-second heating wire part 142, the first-third heating wire part 143, the first-fourth heating wire part 144, the second-first heating wire part 241, the second-second heating wire part 242, the second-third heating wire part 243, and the second-fourth heating wire part 244 may all be arranged so as not to overlap each other, and the first-second heating wire part 142 and the second-second heating wire part 242, which are disposed closest to the folding part 300 among the first heating wire 140 and the second heating wire 240, may be disposed parallel to the folding part 300 so as not to traverse the folding part 300. In addition, the first-third heating wire part 143 and the second-third heating wire part 243, which are perpendicular to the folding part 300, may be disposed relatively far from the folding part 300. In other words, even when the first mat 1 and the second mat 2 are folded to overlap each other, a negligent accident such as folding, deviation, or mutual contact of the first heating wire 140 and the second heating wire 240 may be prevented. Accordingly, stability and use convenience of the user may be improved.

The second top fabric 250 may be stacked on the second heating wire 240. For example, the second top fabric 250 may include a non-woven fabric. Similar to the first heating wire 140, the second heating wire 240 may be bonded and fixed between the second bottom fabric 230 and the second top fabric 250. That is, a space between the second bottom fabric 230 and the second top fabric 250 may be minimized, and the second heating wire 240 may be fixed to the second bottom fabric 230 and the second top fabric 250. Accordingly, the second heating wire 240 may be prevented from being separated from the second bottom fabric 230 and the second top fabric 250, washability may be achieved, and a possibility of an accident such as fire may be reduced.

The exterior fabric 260 may be stacked on the second top fabric 250. The exterior fabric 260 of the second main body 200 may be formed integrally with the exterior fabric 160 of the first main body 100. Similarly, the exterior fabric 260 may include a pattern on the top surface making contact with the user. For example, the exterior fabric 260 may include a floor paper pattern, a wood section pattern, a marble pattern, and the like, but is not limited thereto.

The folding part 300 may be provided so as to be bent to allow the first main body 100 and the second main body 200 to overlap each other between the first main body 100 and the second main body 200. The folding part 300 may include a structure in which the anti-slip fabrics 110 and 210, the base fabrics 120 and 220, and the exterior fabrics 160 and 260 are stacked. In other words, the folding part 300 does not include the first bottom fabric 130, the first heating wire 140, the first top fabric 150, the second bottom fabric 230, the second heating wire 240, and the second top fabric 250, so that the stacked structure may be relatively thinner than a thickness of each of the first main body 100 and the second main body 200. Accordingly, the first main body 100 and the second main body 200 may easily overlap each other through the folding part 300 that is relatively thin, so that storage and mobility of the double earthing mat may be improved.

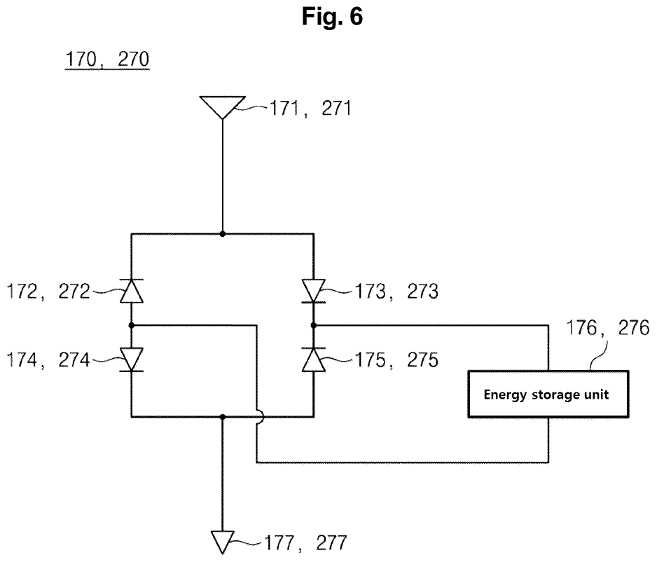

FIG. 6 is a view for describing an energy conversion unit of the double earthing mat according to the embodiment of the present invention.

Referring to FIG. 6, the first controller 10 and the second controller 20 of the double earthing mat may include energy conversion units 170 and 270 for converting electromagnetic waves generated inside and/or outside the controllers 10 and 20 into electric energy.

The energy conversion units 170 and 270 may include conversion units 171 and 271, rectification units 172, 173, 174, 175, 272, 273, 274, and 275, energy storage units 176 and 276, and grounding units 177 and 277.

The conversion units 171 and 271 may convert the electromagnetic waves generated inside and/or outside the first controller 10 and the second controller 20 into an alternating current. According to one embodiment, the electromagnetic waves may be generated in the first controller 10, the second controller 20, the first main body 100, and the second main body 200, and the electromagnetic waves generated in the first controller 10, the second controller 20, the first main body 100, and the second main body 200 may be converted into the alternating current in the conversion units 171 and 271. The conversion units 171 and 271 may be formed on an inner surface of the first controller 10 and/or the second controller 20 so as to convert the electromagnetic waves generated inside and/or outside the first controller 10 and/or the second controller 20 into the alternating current. For example, the conversion units 171 and 271 may be conductive films formed of copper. The conversion units 171 and 271 may serve as antennas.

The alternating current may be a surface current generated when external electromagnetic waves make contact with conductive objects (the conversion units 171 and 271). The surface current may flow along surfaces of the conversion units 171 and 271.

The rectification units 172 to 175 and 272 to 275 may rectify the alternating current converted by the conversion units 171 and 271. The rectification units 172 to 175 and 272 to 275 may transmit the rectified alternating current to the energy storage units 176 and 276. The energy storage units 176 and 276 may receive grounding from the grounding units 177 and 277, and may store the rectified alternating current in the form of electric energy.

The rectification units 172 to 175 and 272 to 275 may include first diodes 172 and 272, second diodes 173 and 273, third diodes 174 and 274, and fourth diodes 175 and 275. An input node to which the alternating current is input through the conversion units 171 and 271 may be provided.

Cathodes of the first diodes 172 and 272 may be connected to the input node. Anodes of the first diodes 172 and 272 may be connected to anodes of the third diodes 174 and 274.

Anodes of the second diodes 173 and 273 may be connected to the input node. Cathodes of the second diodes 173 and 273 may be connected to cathodes of the fourth diodes 175 and 275.

The anodes of the third diodes 174 and 274 may be connected to the anodes of the first diodes 172 and 272. Cathodes of the third diodes 174 and 274 may be connected to anodes of the fourth diodes 175 and 275, and may be connected to the grounding units 177 and 277 so as to receive grounding.

The cathodes of the fourth diodes 175 and 275 may be connected to the cathodes of the second diodes 173 and 273. The anodes of the fourth diodes 175 and 275 may be connected to the cathodes of the third diodes 174 and 274, and may be connected to the grounding units 177 and 277 so as to receive grounding.

The energy storage units 176 and 276 may include energy storage elements (e.g., capacitors). One ends of the energy storage units 176 and 276 may be connected to the anodes of the first diodes 172 and 272 and the anodes of the third diodes 174 and 274. Opposite ends of the energy storage units 176 and 276 may be connected to the cathodes of the second diodes 173 and 273 and the cathodes of the fourth diodes 175 and 275.

An alternating current having a negative (−) polarity among the alternating currents provided to the input node (the alternating current converted by the conversion units 171 and 271 may pass through the first diodes 172 and 272 so as to be provided to a first node. Conversely, an alternating current having a positive (+) polarity among the alternating currents provided to the input node may pass through the second diodes 173 and 273 so as to be provided to a second node. Accordingly, electric energy may be stored in the energy storage units 176 and 276 connected to the first node and the second node.

The grounding units 177 and 277 may be connected to grounding units of the first controller 10 and/or the second controller 20, so that grounding may be easily implemented.

In other words, the electromagnetic waves generated inside and/or outside the first controller 10 and/or the second controller 20 may be converted into the electric energy through the first controller 10 and/or the second controller 20 including the energy conversion units 170 and 270, and the electric energy may be easily stored.

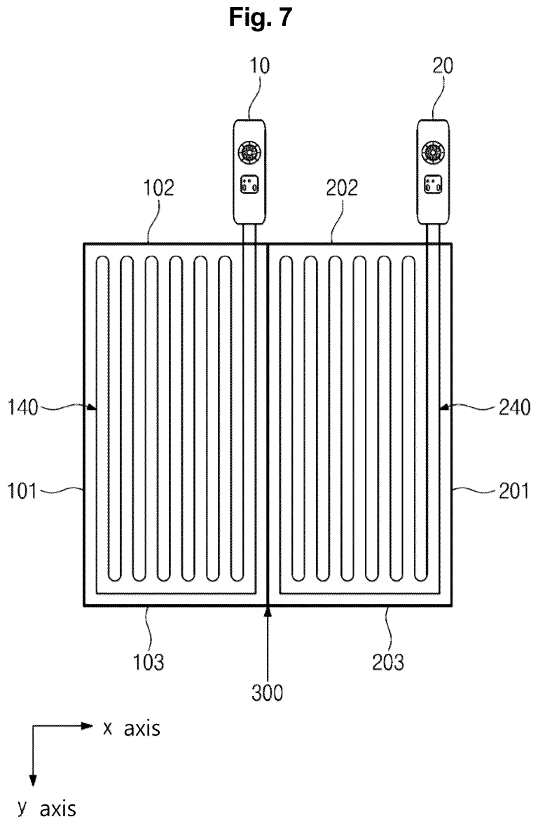

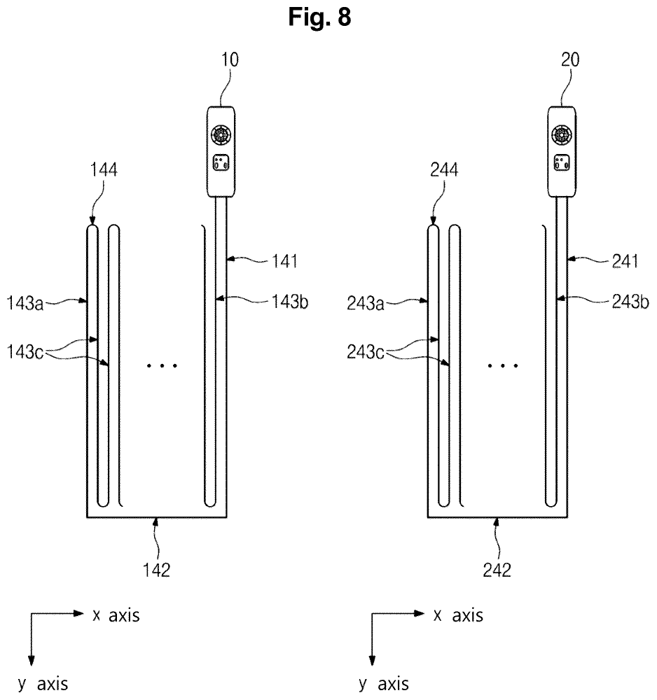

FIGS. 7 and 8 are views for describing a first heating wire and a second heating wire of a double earthing mat according to a first modified example of the present invention.

Referring to FIGS. 7 and 8, according to a double earthing mat of a first modified example of the present invention, a first mat 1 and a second mat 2 may be formed integrally with each other. The double earthing mat may include a top surface making contact with a lying user, and a plate having a thickness with respect to the top surface. According to the double earthing mat, a folding part 300 that is bent so as to allow the first mat 1 and the second mat 2 to overlap each other may be provided between the first mat 1 and the second mat 2.

The first mat 1 may include a first main body 100 in which a first heating wire 140 is disposed, and a first controller 10.

The first main body 100 may be electrically connected to the first controller 10 through a first terminal 10′. The first main body 100 may include a first-first side surface 101, a first-second side surface 102, and a first-third side surface 103, which surround the top surface making contact with the user.

Since the first-first side surface 101, the first-second side surface 102, and the first-third side surface 103 according to the first modified example of the present invention are substantially identical to the first-first side surface 101, the first-second side surface 102, and the first-third side surface 103 according to the embodiment of the present invention, respectively, detailed descriptions thereof will be omitted.

The first controller 10 may be electrically connected to the first main body 100 so as to control a heating level of the first main body 100. The first controller 10 may be coupled onto the first-second side surface 102 that is adjacent to the folding part 300. The first controller 10 may include a dial for controlling the heating level of the first main body 100, a power button, and an LED for checking electromagnetic waves.

A current may flow inside the first heating wire 140 so that the first heating wire 140 may generate heat. The first heating wire 140 may include a first-first heating wire part 141, a second-second heating wire part 142, a third-third heating wire part 143, and a fourth-first heating wire part 144.

One end of the first-first heating wire part 141 may be electrically connected to the first controller 10. An opposite end of the first-first heating wire part 141 may be connected to the first-second heating wire part 142 that will be described below. The first-first heating wire part 141 may extend parallel to the folding part 300 in a second direction (y-axis direction) toward the first-third side surface 103 from the first-second side surface 102.

One end of the first-second heating wire part 142 may be connected to the opposite end of the first-first heating wire part 141. An opposite end of the first-second heating wire part 142 may be connected to the first-third heating wire part 143 that will be described below. The first-second heating wire part 142 may be parallel to the first-third side surface 103, and may extend in a direction ((−x)-axis direction) that is antiparallel to a first direction (x-axis direction) toward the folding part 300 from the first-first side surface 101.

A plurality of first-third heating wire parts 143 may extend in the second direction (y-axis direction), and may be spaced apart from each other in the first direction (x-axis direction). The first-third heating wire part 143 may include an outermost first-third heating wire part 143a, an innermost first-third heating wire part 143b, and an intermediate first-third heating wire part 143c.

One end of the outermost first-third heating wire part 143a may be connected to the opposite end of the first-second heating wire part 142. An opposite end of the outermost first-third heating wire part 143a may be connected to one end of the intermediate first-third heating wire part 143c. The outermost first-third heating wire part 143a may be disposed closest to the first-first side surface 101 among the first-third heating wire parts 143.

One end of the innermost first-third heating wire part 143b may be electrically connected to the first controller 10. An opposite end of the innermost first-third heating wire part 143b may be connected to an opposite end of the intermediate first-third heating wire part 143c. The innermost first-third heating wire part 143b may be disposed closest to the first-first heating wire part 141 among the first-third heating wire parts 143.

The intermediate first-third heating wire part 143c may be disposed between the outermost first-third heating wire part 143a and the innermost first-third heating wire part 143b. As described above, the one end of the intermediate first-third heating wire part 143c may be connected to the opposite end of the outermost first-third heating wire part 143a, and the opposite end of the intermediate first-third heating wire part 143c may be connected to the opposite end of the innermost first-third heating wire part 143b. According to one embodiment, a plurality of intermediate first-third heating wire parts 143c may be provided.

The first-fourth heating wire part 144 may connect one end and an opposite end of adjacent first-third heating wire parts 143. The first-fourth heating wire part 144 may connect the opposite end of the outermost first-third heating wire part 143a to the one end of the intermediate first-third heating wire part 143c, and may connect the opposite end of the intermediate first-third heating wire part 143c to the opposite end of the innermost first-third heating wire part 143b. When a plurality of intermediate first-third heating wire parts 143c are provided, the first-fourth heating wire part 144 may connect one end of the intermediate first-third heating wire part 143c to an opposite end of an adjacent intermediate first-third heating wire part 143c. For example, the first-fourth heating wire part 144 may include a semicircular arc shape as shown in the drawings.

As a result, the first-first heating wire part 141, the first-second heating wire part 142, the first-third heating wire part 143, and the first-fourth heating wire part 144 may be arranged so as not to overlap each other. In addition, the first-first heating wire part 141 that is parallel to the folding part 300 may be disposed adjacent to the folding part 300, a plurality of first-third heating wire parts 143 that are parallel to the folding part 300 may be arranged, and the first-fourth heating wire part 144 having a semicircular arc shape may be disposed relatively far from the folding part 300, so that stability may be further improved.

The second mat 2 may include a second main body 200 in which a second heating wire 240 is disposed, and a second controller 20.

The second main body 200 may be electrically connected to the second controller 20 through a second terminal 20′. The second main body 200 may include a second-first side surface 201, a second-second side surface 202, and a second-third side surface 203, which surround the top surface making contact with the user.

Since the second-first side surface 201, the second-second side surface 202, and the second-third side surface 203 according to the first modified example of the present invention are substantially identical to the second-first side surface 201, the second-second side surface 202, and the second-third side surface 203 according to the embodiment of the present invention, respectively, detailed descriptions thereof will be omitted.

The second controller 20 may be electrically connected to the second main body 200 so as to control a heating level of the second main body 200. The second controller 20 may be coupled onto the second-second side surface 202 that is adjacent to the folding part 300. The second controller 20 may include a dial for controlling the heating level of the second main body 200, a power button, and an LED for checking electromagnetic waves.

A current may flow inside the second heating wire 240 so that the second heating wire 240 may generate heat. One end and an opposite end of the second heating wire 240 may be electrically connected to the second controller 20. The second heating wire 240 may include a second-first heating wire part 241, a second-second heating wire part 242, a second-third heating wire part 243, and a second-fourth heating wire part 244.

One end of the second-first heating wire part 241 may be electrically connected to the second controller 20. An opposite end of the second-first heating wire part 241 may be connected to the second-second heating wire part 242 that will be described below. The second-first heating wire part 241 may extend parallel to the second-first side surface 201 in the second direction (y-axis direction) toward the second-third side surface 203 from the second-second side surface 202.

One end of the second-second heating wire part 242 may be connected to the opposite end of the second-first heating wire part 241. An opposite end of the second-second heating wire part 242 may be connected to the second-third heating wire part 243 that will be described below. The second-second heating wire part 242 may be parallel to the second-third side surface 203, and may extend in a direction ((−x)-axis direction) that is antiparallel to the first direction (x-axis direction) toward the second-first side surface 201 from the folding part 300.

A plurality of second-third heating wire parts 243 may extend in the second direction (y-axis direction), and may be spaced apart from each other in the first direction (x-axis direction). The second-third heating wire part 243 may include an innermost second-third heating wire part 243a, an outermost second-third heating wire part 243b, and an intermediate second-third heating wire part 243c.

One end of the innermost second-third heating wire part 243a may be connected to the opposite end of the second-second heating wire part 242. An opposite end of the innermost second-third heating wire part 243a may be connected to one end of the intermediate second-third heating wire part 243c that will be described below. The innermost second-third heating wire part 243a may be disposed closest to the folding part 300 among the second-third heating wire parts 243.

One end of the outermost second-third heating wire part 243b may be electrically connected to the second controller 20. An opposite end of the outermost second-third heating wire part 243b may be connected to an opposite end of the intermediate second-third heating wire part 243c. The outermost second-third heating wire part 243b may be disposed closest to the second-first heating wire part 241 among the second-third heating wire parts 243.

The intermediate second-third heating wire part 243c may be disposed between the innermost second-third heating wire part 243a and the outermost second-third heating wire part 243b. As described above, the one end of the intermediate second-third heating wire part 243c may be connected to the opposite end of the innermost second-third heating wire part 243a, and the opposite end of the intermediate second-third heating wire part 243c may be connected to the opposite end of the outermost second-third heating wire part 243b. According to one embodiment, a plurality of intermediate second-third heating wire parts 243c may be provided.

The second-fourth heating wire part 244 may connect one end and an opposite end of adjacent second-third heating wire parts 243. The second-fourth heating wire part 244 may connect the opposite end of the innermost second-third heating wire part 243a to the one end of the intermediate second-third heating wire part 243c, and may connect the opposite end of the intermediate second-third heating wire part 243c to the opposite end of the outermost second-third heating wire part 243b. When a plurality of intermediate second-third heating wire parts 243c are provided, the second-fourth heating wire part 244 may connect one end of the intermediate second-third heating wire part 243c to an opposite end of an adjacent intermediate second-third heating wire part 243c. For example, the second-fourth heating wire part 244 may include a semicircular arc shape as shown in the drawings.

In other words, the second-first heating wire part 241, the second-second heating wire part 242, the second-third heating wire part 243, and the second-fourth heating wire part 244 may be arranged so as not to overlap each other. In addition, a plurality of second-third heating wire parts 243 that are parallel to the folding part 300 may be arranged adjacent to the folding part 300, so that stability may be improved.

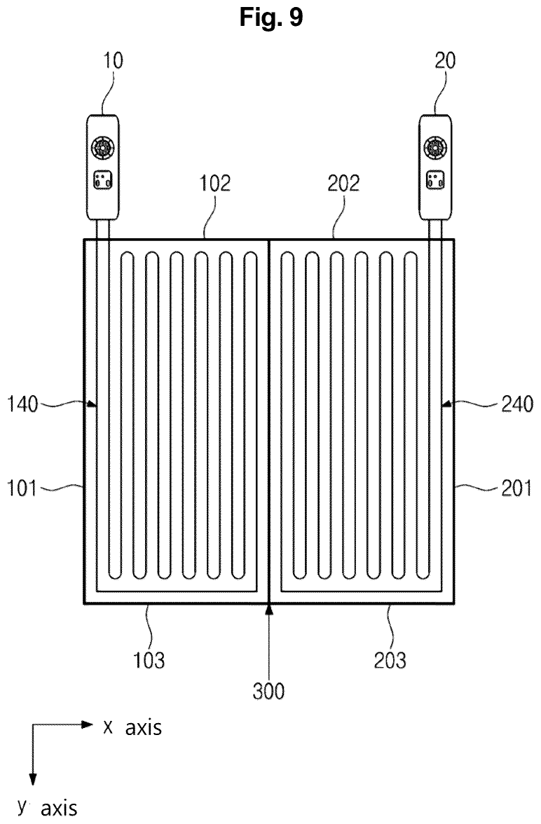

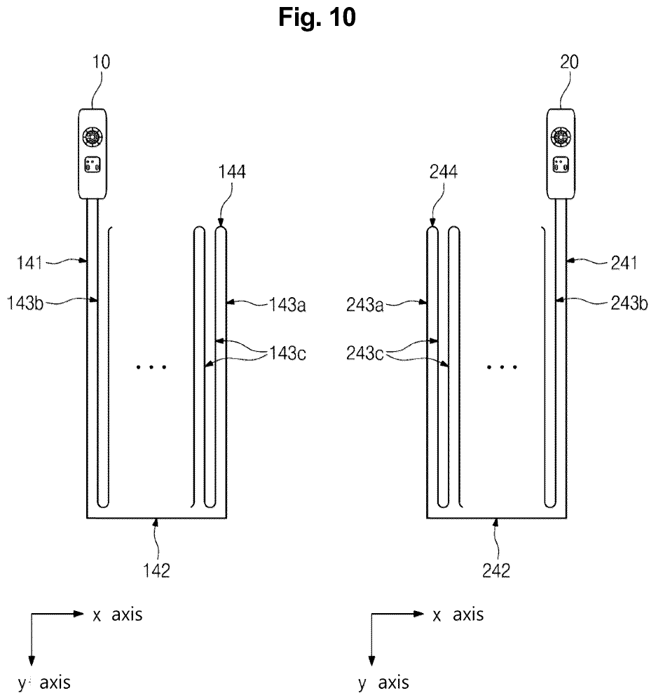

FIGS. 9 and 10 are views for describing a first heating wire and a second heating wire of a double earthing mat according to a second modified example of the present invention.

Referring to FIGS. 9 and 10, according to a double earthing mat of a second modified example of the present invention, a first mat 1 and a second mat 2 may be formed integrally with each other. The double earthing mat may include a top surface making contact with a lying user, and a plate having a thickness with respect to the top surface. According to the double earthing mat, a folding part 300 that is bent so as to allow the first mat 1 and the second mat 2 to overlap each other may be provided between the first mat 1 and the second mat 2.

The first mat 1 may include a first main body 100 in which a first heating wire 140 is disposed, and a first controller 10.

The first main body 100 may be electrically connected to the first controller 10 through a first terminal 10′. The first main body 100 may include a first-first side surface 101, a first-second side surface 102, and a first-third side surface 103, which surround the top surface making contact with the user.

Since the first-first side surface 101, the first-second side surface 102, and the first-third side surface 103 according to the second modified example of the present invention are substantially identical to the first-first side surface 101, the first-second side surface 102, and the first-third side surface 103 according to the embodiment of the present invention, respectively, detailed descriptions thereof will be omitted.

The first controller 10 may be electrically connected to the first main body 100 so as to control a heating level of the first main body 100. The first controller 10 may be coupled onto the first-second side surface 102 that is adjacent to the first-first side surface 101. The first controller 10 may include a dial for controlling the heating level of the first main body 100, a power button, and an LED for checking electromagnetic waves.

A current may flow inside the first heating wire 140 so that the first heating wire 140 may generate heat. The first heating wire 140 may include a first-first heating wire part 141, a second-second heating wire part 142, a third-third heating wire part 143, and a fourth-first heating wire part 144.

One end of the first-first heating wire part 141 may be electrically connected to the first controller 10. An opposite end of the first-first heating wire part 141 may be connected to the first-second heating wire part 142 that will be described below. The first-first heating wire part 141 may extend parallel to the first-first side surface 101 in a second direction (y-axis direction) toward the first-third side surface 103 from the first-second side surface 102.

One end of the first-second heating wire part 142 may be connected to the opposite end of the first-first heating wire part 141. An opposite end of the first-second heating wire part 142 may be connected to the first-third heating wire part 143 that will be described below. The first-second heating wire part 142 may be parallel to the first-third side surface 103, and may extend in a first direction (x-axis direction) toward the folding part 300 from the first-first side surface 101.

A plurality of first-third heating wire parts 143 may extend in the second direction (y-axis direction), and may be spaced apart from each other in the first direction (x-axis direction). The first-third heating wire part 143 may include an innermost first-third heating wire part 143a, an outermost first-third heating wire part 143b, and an intermediate first-third heating wire part 143c.

One end of the innermost first-third heating wire part 143a may be connected to the opposite end of the first-second heating wire part 142. An opposite end of the innermost first-third heating wire part 143a may be connected to one end of the intermediate first-third heating wire part 143c. The innermost first-third heating wire part 143a may be disposed closest to the folding part 300 among the first-third heating wire parts 143.

One end of the outermost first-third heating wire part 143b may be electrically connected to the first controller 10. An opposite end of the outermost first-third heating wire part 143b may be connected to an opposite end of the intermediate first-third heating wire part 143c. The outermost first-third heating wire part 143b may be disposed closest to the first-first heating wire part 141 among the first-third heating wire parts 143.

The intermediate first-third heating wire part 143c may be disposed between the innermost first-third heating wire part 143a and the outermost first-third heating wire part 143b. As described above, the one end of the intermediate first-third heating wire part 143c may be connected to the opposite end of the innermost first-third heating wire part 143a, and the opposite end of the intermediate first-third heating wire part 143c may be connected to the opposite end of the outermost first-third heating wire part 143b. According to one embodiment, a plurality of intermediate first-third heating wire parts 143c may be provided.

The first-fourth heating wire part 144 may connect one end and an opposite end of adjacent first-third heating wire parts 143. The first-fourth heating wire part 144 may connect the opposite end of the innermost first-third heating wire part 143a to the one end of the intermediate first-third heating wire part 143c, and may connect the opposite end of the intermediate first-third heating wire part 143c to the opposite end of the outermost first-third heating wire part 143b. When a plurality of intermediate first-third heating wire parts 143c are provided, the first-fourth heating wire part 144 may connect one end of the intermediate first-third heating wire part 143c to an opposite end of an adjacent intermediate first-third heating wire part 143c. For example, the first-fourth heating wire part 144 may include a semicircular arc shape as shown in the drawings.

As a result, the first-first heating wire part 141, the first-second heating wire part 142, the first-third heating wire part 143, and the first-fourth heating wire part 144 may be arranged so as not to overlap each other. In addition, a plurality of first-third heating wire parts 143 may be arranged parallel to the folding part 300, so that stability may be further improved.

The second mat 2 may include a second main body 200 in which a second heating wire 240 is disposed, and a second controller 20.

The second main body 200 may be electrically connected to the second controller 20 through a second terminal 20′. The second main body 200 may include a second-first side surface 201, a second-second side surface 202, and a second-third side surface 203, which surround the top surface making contact with the user.

Since the second-first side surface 201, the second-second side surface 202, and the second-third side surface 203 according to the second modified example of the present invention are substantially identical to the second-first side surface 201, the second-second side surface 202, and the second-third side surface 203 according to the embodiment of the present invention, respectively, detailed descriptions thereof will be omitted.

The second controller 20 may be electrically connected to the second main body 200 so as to control a heating level of the second main body 200. The second controller 20 may be coupled onto the second-second side surface 202 that is adjacent to the second-first side surface 201. The second controller 20 may include a dial for controlling the heating level of the second main body 200, a power button, and an LED for checking electromagnetic waves.

A current may flow inside the second heating wire 240 so that the second heating wire 240 may generate heat. One end and an opposite end of the second heating wire 240 may be electrically connected to the second controller 20. The second heating wire 240 may include a second-first heating wire part 241, a second-second heating wire part 242, a second-third heating wire part 243, and a second-fourth heating wire part 244.

One end of the second-first heating wire part 241 may be electrically connected to the second controller 20. An opposite end of the second-first heating wire part 241 may be connected to the second-second heating wire part 242 that will be described below. The second-first heating wire part 241 may extend parallel to the second-first side surface 201 in the second direction (y-axis direction). The second-first heating wire part 241 may be provided in a shape that is mirror-symmetrical with the first-first heating wire part 141 based on the folding part 300.

One end of the second-second heating wire part 242 may be connected to the opposite end of the second-first heating wire part 241. An opposite end of the second-second heating wire part 242 may be connected to the second-third heating wire part 243 that will be described below. The second-second heating wire part 242 may be parallel to the second-third side surface 203, and may extend in a direction ((−x)-axis direction) that is antiparallel to the first direction (x-axis direction). The second-second heating wire part 242 may be provided in a shape that is mirror-symmetrical with the first-second heating wire part 142 based on the folding part 300.

A plurality of second-third heating wire parts 243 may extend in the second direction (y-axis direction), and may be spaced apart from each other in the first direction (x-axis direction). The second-third heating wire part 243 may include an innermost second-third heating wire part 243a, an outermost second-third heating wire part 243b, and an intermediate second-third heating wire part 243c.

One end of the innermost second-third heating wire part 243a may be connected to the opposite end of the second-second heating wire part 242. An opposite end of the innermost second-third heating wire part 243a may be connected to one end of the intermediate second-third heating wire part 243c that will be described below. The innermost second-third heating wire part 243a may be disposed closest to the folding part 300 among the second-third heating wire parts 243.

One end of the outermost second-third heating wire part 243b may be electrically connected to the second controller 20. An opposite end of the outermost second-third heating wire part 243b may be connected to an opposite end of the intermediate second-third heating wire part 243c. The outermost second-third heating wire part 243b may be disposed closest to the second-first heating wire part 241 among the second-third heating wire parts 243.

The intermediate second-third heating wire part 243c may be disposed between the innermost second-third heating wire part 243a and the outermost second-third heating wire part 243b. As described above, the one end of the intermediate second-third heating wire part 243c may be connected to the opposite end of the innermost second-third heating wire part 243a, and the opposite end of the intermediate second-third heating wire part 243c may be connected to the opposite end of the outermost second-third heating wire part 243b. According to one embodiment, a plurality of intermediate second-third heating wire parts 243c may be provided.

The second-fourth heating wire part 244 may connect one end and an opposite end of adjacent second-third heating wire parts 243. The second-fourth heating wire part 244 may connect the opposite end of the innermost second-third heating wire part 243a to the one end of the intermediate second-third heating wire part 243c, and may connect the opposite end of the intermediate second-third heating wire part 243c to the opposite end of the outermost second-third heating wire part 243b. When a plurality of intermediate second-third heating wire parts 243c are provided, the second-fourth heating wire part 244 may connect one end of the intermediate second-third heating wire part 243c to an opposite end of an adjacent intermediate second-third heating wire part 243c. For example, the second-fourth heating wire part 244 may include a semicircular arc shape as shown in the drawings.

In other words, the second-first heating wire part 241, the second-second heating wire part 242, the second-third heating wire part 243, and the second-fourth heating wire part 244 may be arranged so as not to overlap each other. In addition, a plurality of second-third heating wire parts 243 that are parallel to the folding part 300 may be arranged adjacent to the folding part 300, so that stability may be improved.

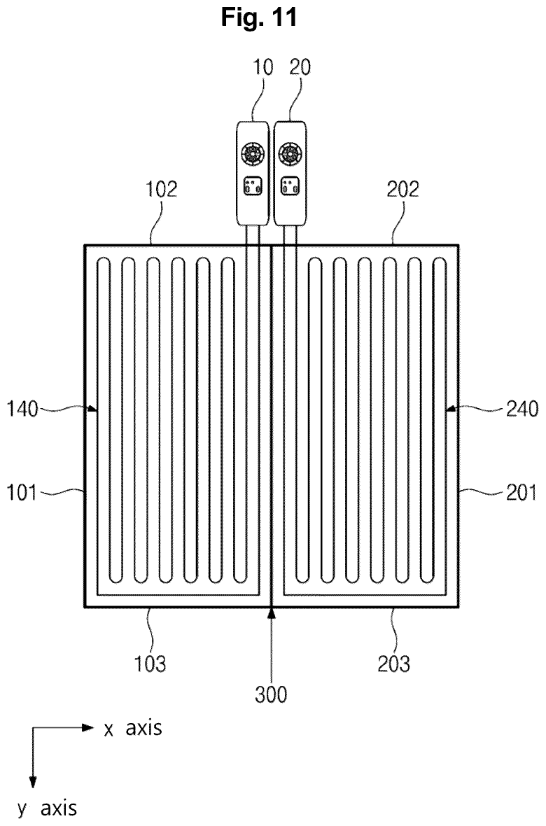

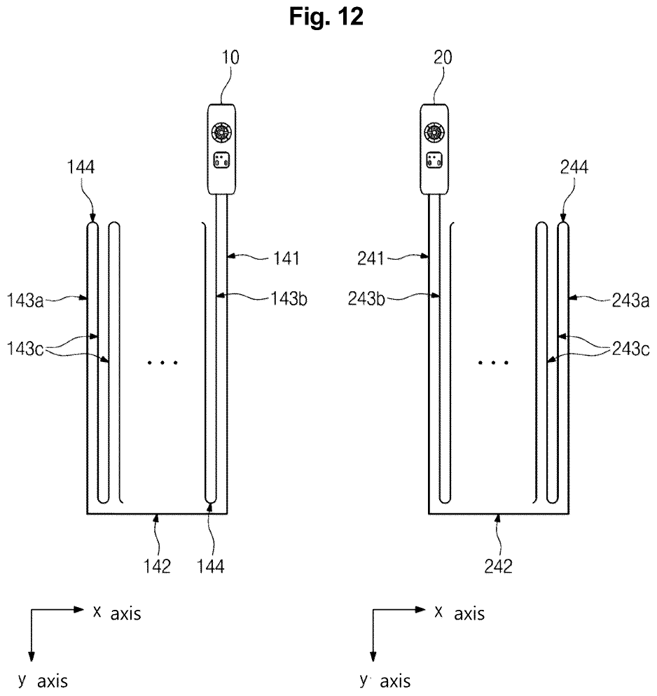

FIGS. 11 and 12 are views for describing a first heating wire and a second heating wire of a double earthing mat according to a third modified example of the present invention.

Referring to FIGS. 11 and 12, according to a double earthing mat of a third modified example of the present invention, a first mat 1 and a second mat 2 may be formed integrally with each other. The double earthing mat may include a top surface making contact with a lying user, and a plate having a thickness with respect to the top surface. According to the double earthing mat, a folding part 300 that is bent so as to allow the first mat 1 and the second mat 2 to overlap each other may be provided between the first mat 1 and the second mat 2.

The first mat 1 may include a first main body 100 in which a first heating wire 140 is disposed, and a first controller 10.

The first main body 100 may be electrically connected to the first controller 10 through a first terminal 10′. The first main body 100 may include a first-first side surface 101, a first-second side surface 102, and a first-third side surface 103, which surround the top surface making contact with the user.

Since the first-first side surface 101, the first-second side surface 102, and the first-third side surface 103 according to the third modified example of the present invention are substantially identical to the first-first side surface 101, the first-second side surface 102, and the first-third side surface 103 according to the embodiment of the present invention, respectively, detailed descriptions thereof will be omitted.

The first controller 10 may be electrically connected to the first main body 100 so as to control a heating level of the first main body 100. The first controller 10 may be coupled onto the first-second side surface 102 that is adjacent to the folding part 300. The first controller 10 may include a dial for controlling the heating level of the first main body 100, a power button, and an LED for checking electromagnetic waves.

A current may flow inside the first heating wire 140 so that the first heating wire 140 may generate heat. The first heating wire 140 may include a first-first heating wire part 141, a second-second heating wire part 142, a third-third heating wire part 143, and a fourth-first heating wire part 144.

One end of the first-first heating wire part 141 may be electrically connected to the first controller 10. An opposite end of the first-first heating wire part 141 may be connected to the first-second heating wire part 142 that will be described below. The first-first heating wire part 141 may extend parallel to the folding part 300 in a second direction (y-axis direction) toward the first-third side surface 103 from the first-second side surface 102.

One end of the first-second heating wire part 142 may be connected to the opposite end of the first-first heating wire part 141. An opposite end of the first-second heating wire part 142 may be connected to the first-third heating wire part 143 that will be described below. The first-second heating wire part 142 may be parallel to the first-third side surface 103, and may extend in a direction ((−x)-axis direction) that is antiparallel to a first direction (x-axis direction) toward the folding part 300 from the first-first side surface 101.

A plurality of first-third heating wire parts 143 may extend in the second direction (y-axis direction), and may be spaced apart from each other in the first direction (x-axis direction). The first-third heating wire part 143 may include an outermost first-third heating wire part 143a, an innermost first-third heating wire part 143b, and an intermediate first-third heating wire part 143c.

One end of the outermost first-third heating wire part 143a may be connected to the opposite end of the first-second heating wire part 142. An opposite end of the outermost first-third heating wire part 143a may be connected to one end of the intermediate first-third heating wire part 143c. The outermost first-third heating wire part 143a may be disposed closest to the first-first side surface 101 among the first-third heating wire parts 143.

One end of the innermost first-third heating wire part 143b may be electrically connected to the first controller 10. An opposite end of the innermost first-third heating wire part 143b may be connected to an opposite end of the intermediate first-third heating wire part 143c. The innermost first-third heating wire part 143b may be disposed closest to the first-first heating wire part 141 among the first-third heating wire parts 143.

The intermediate first-third heating wire part 143c may be disposed between the outermost first-third heating wire part 143a and the innermost first-third heating wire part 143b. As described above, the one end of the intermediate first-third heating wire part 143c may be connected to the opposite end of the outermost first-third heating wire part 143a, and the opposite end of the intermediate first-third heating wire part 143c may be connected to the opposite end of the innermost first-third heating wire part 143b. According to one embodiment, a plurality of intermediate first-third heating wire parts 143c may be provided.

The first-fourth heating wire part 144 may connect one end and an opposite end of adjacent first-third heating wire parts 143. The first-fourth heating wire part 144 may connect the opposite end of the outermost first-third heating wire part 143a to the one end of the intermediate first-third heating wire part 143c, and may connect the opposite end of the intermediate first-third heating wire part 143c to the opposite end of the innermost first-third heating wire part 143b. When a plurality of intermediate first-third heating wire parts 143c are provided, the first-fourth heating wire part 144 may connect one end of the intermediate first-third heating wire part 143c to an opposite end of an adjacent intermediate first-third heating wire part 143c. For example, the first-fourth heating wire part 144 may include a semicircular arc shape as shown in the drawings.

As a result, the first-first heating wire part 141, the first-second heating wire part 142, the first-third heating wire part 143, and the first-fourth heating wire part 144 may be arranged so as not to overlap each other. In addition, the first-first heating wire part 141 that is parallel to the folding part 300 and the innermost first-third heating wire part 143b may be disposed adjacent to the folding part 300, and the first-fourth heating wire part 144 having a semicircular arc shape may be disposed relatively far from the folding part 300, so that stability may be further improved.

The second mat 2 may include a second main body 200 in which a second heating wire 240 is disposed, and a second controller 20.

The second main body 200 may be electrically connected to the second controller 20 through a second terminal 20′. The second main body 200 may include a second-first side surface 201, a second-second side surface 202, and a second-third side surface 203, which surround the top surface making contact with the user.

Since the second-first side surface 201, the second-second side surface 202, and the second-third side surface 203 according to the third modified example of the present invention are substantially identical to the second-first side surface 201, the second-second side surface 202, and the second-third side surface 203 according to the embodiment of the present invention, respectively, detailed descriptions thereof will be omitted.

The second controller 20 may be electrically connected to the second main body 200 so as to control a heating level of the second main body 200. The second controller 20 may be coupled onto the second-second side surface 202 that is adjacent to the folding part 300. The second controller 20 may include a dial for controlling the heating level of the second main body 200, a power button, and an LED for checking electromagnetic waves.

A current may flow inside the second heating wire 240 so that the second heating wire 240 may generate heat. One end and an opposite end of the second heating wire 240 may be electrically connected to the second controller 20. The second heating wire 240 may include a second-first heating wire part 241, a second-second heating wire part 242, a second-third heating wire part 243, and a second-fourth heating wire part 244.

One end of the second-first heating wire part 241 may be electrically connected to the second controller 20. An opposite end of the second-first heating wire part 241 may be connected to the second-second heating wire part 242 that will be described below. The second-first heating wire part 241 may extend parallel to the second-first side surface 201 in the second direction (y-axis direction) toward the second-third side surface 203 from the second-second side surface 202. The second-first heating wire part 241 may be provided in a shape that is mirror-symmetrical with the first-first heating wire part 141 based on the folding part 300.

One end of the second-second heating wire part 242 may be connected to the opposite end of the second-first heating wire part 241. An opposite end of the second-second heating wire part 242 may be connected to the second-third heating wire part 243 that will be described below. The second-second heating wire part 242 may be parallel to the second-third side surface 203, and may extend in the first direction (x-axis direction) toward the second-first side surface 201 from the folding part 300. The second-second heating wire part 242 may be provided in a shape that is mirror-symmetrical with the first-second heating wire part 142 based on the folding part 300.

A plurality of second-third heating wire parts 243 may extend in the second direction (y-axis direction), and may be spaced apart from each other in the first direction (x-axis direction). The second-third heating wire part 243 may include an outermost second-third heating wire part 243a, an innermost second-third heating wire part 243b, and an intermediate second-third heating wire part 243c.

One end of the outermost second-third heating wire part 243a may be connected to the opposite end of the second-second heating wire part 242. An opposite end of the outermost second-third heating wire part 243a may be connected to one end of the intermediate second-third heating wire part 243c that will be described below. The outermost second-third heating wire part 243a may be disposed closest to the folding part 300 among the second-third heating wire parts 243.

One end of the innermost second-third heating wire part 243b may be electrically connected to the second controller 20. An opposite end of the innermost second-third heating wire part 243b may be connected to an opposite end of the intermediate second-third heating wire part 243c. The innermost second-third heating wire part 243b may be disposed closest to the second-first heating wire part 241 among the second-third heating wire parts 243.

The intermediate second-third heating wire part 243c may be disposed between the outermost second-third heating wire part 243a and the innermost second-third heating wire part 243b. As described above, the one end of the intermediate second-third heating wire part 243c may be connected to the opposite end of the outermost second-third heating wire part 243a, and the opposite end of the intermediate second-third heating wire part 243c may be connected to the opposite end of the innermost second-third heating wire part 243b. According to one embodiment, a plurality of intermediate second-third heating wire parts 243c may be provided.

The second-fourth heating wire part 244 may connect one end and an opposite end of adjacent second-third heating wire parts 243. The second-fourth heating wire part 244 may connect the opposite end of the outermost second-third heating wire part 243a to the one end of the intermediate second-third heating wire part 243c, and may connect the opposite end of the intermediate second-third heating wire part 243c to the opposite end of the innermost second-third heating wire part 243b. When a plurality of intermediate second-third heating wire parts 243c are provided, the second-fourth heating wire part 244 may connect one end of the intermediate second-third heating wire part 243c to an opposite end of an adjacent intermediate second-third heating wire part 243c. For example, the second-fourth heating wire part 244 may include a semicircular arc shape as shown in the drawings.

In other words, the second-first heating wire part 241, the second-second heating wire part 242, the second-third heating wire part 243, and the second-fourth heating wire part 244 may be arranged so as not to overlap each other. In addition, the second-first heating wire part 241 that is parallel to the folding part 300 and the innermost second-third heating wire part 243b may be disposed adjacent to the folding part 300, and the second-fourth heating wire part 244 having a semicircular arc shape may be disposed relatively far from the folding part 300.

As a result, the first heating wire 140 and the second heating wire 240 of the double earthing mat according to the third modified example of the present invention may be arranged more stably as compared with the first and second modified examples of the present invention.

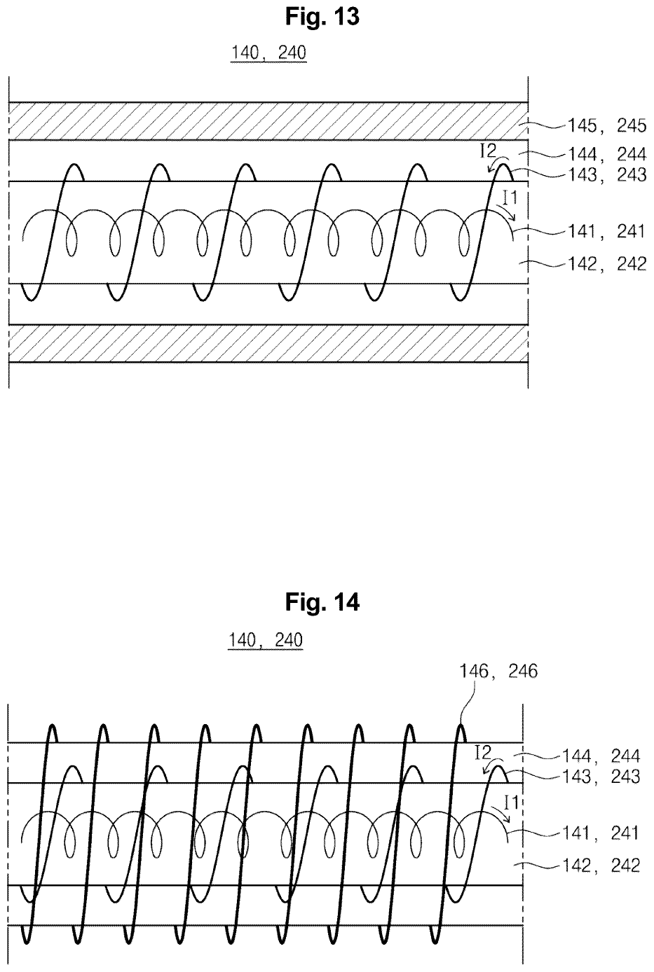

FIG. 13 is a view for describing a first heating wire and a second heating wire of a double earthing mat according to a fourth modified example of the present invention.

Referring to FIG. 13, a first heating wire 140 and a second heating wire 240 of a double earthing mat according to a fourth modified example of the present invention may include first coils 141 and 241, first insulating layers 142 and 242, second coils 143 and 243, second insulating layers 144 and 244, and electromagnetic wave absorption parts 145 and 245.

The first coils 141 and 241 may be provided in the form of coils. A first current I1 may flow through the first coils 141 and 241. Heat may be generated from the first coils 141 and 241 by the first current I1. In addition, electromagnetic waves may be generated from the first coils 141 and 241 due to a direction in which the first coils 141 and 241 in the form of coils are wound and a direction of the first current I1. A plurality of first coils 141 and 241 may be provided.

The first insulating layers 142 and 242 may surround the first coils 141 and 241. The first insulating layers 142 and 242 may be formed of various insulating materials. For example, the first insulating layers 142 and 242 may be formed of silicone, Teflon, PVC, or the like.

The second coils 143 and 243 may be provided in the form of coils that surround the first insulating layers 142 and 242. A second current I2 may flow through the second coils 143 and 243. The second current I2 flowing through the second coils 143 and 243 and the first current I1 flowing through the first coils 141 and 241 may flow in opposite directions.

According to one embodiment, one ends of the first coils 141 and 241 and one ends of the second coils 143 and 243 may be connected to each other. In detail, the first current I1 may be introduced into first ends of the first coils 141 and 241, a heating current (the first current I1) may flow from the first ends of the first coils 141 and 241 to second ends of the first coils 141 and 241, the heating current (the second current I2) may be introduced into first ends of the second coils 143 and 243 connected to the second ends of the first coils 141 and 241, and the heating current (the second current I2) may flow from the first ends of the second coils 143 and 243 to second ends of the second coils 143 and 243. In this case, the first current I1 and the second current I2 may be the same current. In addition, the first ends of the first coils 141 and 241 and the second ends of the second coils 143 and 243 may be connected to a power supply unit for supplying the heating current to the coils 141, 231, 143, and 243.

Alternatively, according to another embodiment, the first coils 141 and 241 and the second coils 143 and 243 may be electrically separated from each other.

As described above, the electromagnetic waves may be generated from the first coils 141 and 241 due to the direction in which the first coils 141 and 241 in the form of coils are wound and the direction of the first current I1. In addition, electromagnetic waves may be generated from the second coils 143 and 243 due to a direction in which the second coils 143 and 243 in the form of coils are wound and a direction of the second current I2. The first coils 141 and 241 and the second coils 143 and 243 may have the same twisting directions, and the directions of the first current I1 and the second current I2 may be antiparallel to each other. Accordingly, a phase difference between the electromagnetic waves generated from the first coils 141 and 241 and the electromagnetic waves generated from the second coils 143 and 243 may be 180°, and the electromagnetic waves generated from the first coils 141 and 241 and the electromagnetic waves generated from the second coils 143 and 243 may have destructive interference. Accordingly, the electromagnetic waves emitted to an outside so as to be introduced into a human body may be minimized.

The second insulating layers 144 and 244 may surround the second coils 143 and 243. The second insulating layers 144 and 244 may be formed of various insulating materials. For example, the second insulating layers 144 and 244 may be formed of silicone, Teflon, PVC, or the like.

The electromagnetic wave absorption parts 145 and 245 may absorb the electromagnetic waves generated from the first coils 141 and 241 and/or the second coils 143 and 243 and emitted to the outside. The electromagnetic wave absorption parts 145 and 245 may be provided in the form of metal foils that surround the second insulating layers 144 and 244.

The electromagnetic wave absorption parts 145 and 245 may absorb the electromagnetic waves and convert the electromagnetic waves into an alternating current.

The alternating current may be a surface current generated when the electromagnetic waves make contact with conductive objects (the electromagnetic wave absorption parts 145 and 245). The surface current may flow along surfaces of the conductive objects (the electromagnetic wave absorption parts 145 and 245).

The electromagnetic wave absorption parts 145 and 245 may be connected to an electromagnetic wave absorption and conversion circuit, and the alternating current may be absorbed by the electromagnetic wave absorption and conversion circuit or converted into electric energy.

FIG. 14 is a view for describing a first heating wire and a second heating wire of a double earthing mat according to a fifth modified example of the present invention.

Referring to FIG. 14, a first heating wire 140 and a second heating wire 240 of a double earthing mat according to a fifth modified example of the present invention may include electromagnetic wave absorption parts 146 and 246 in the form of lines, in addition to the first coils 141 and 241, the first insulating layers 142 and 242, the second coils 143 and 243, and the second insulating layers 144 and 244 described with reference to FIG. 13.

Unlike the configuration described with reference to FIG. 13, the electromagnetic wave absorption parts 146 and 246 may be provided in the form of metal wires. In addition, the electromagnetic wave absorption parts 146 and 246 may be provided in the form of coils that surround the second insulating layers 144 and 244.

Accordingly, even when the mat including a heat supply pipe according to the fifth modified example is folded or subjected to physical stress by a user, the mat may be prevented from being deformed or damaged.

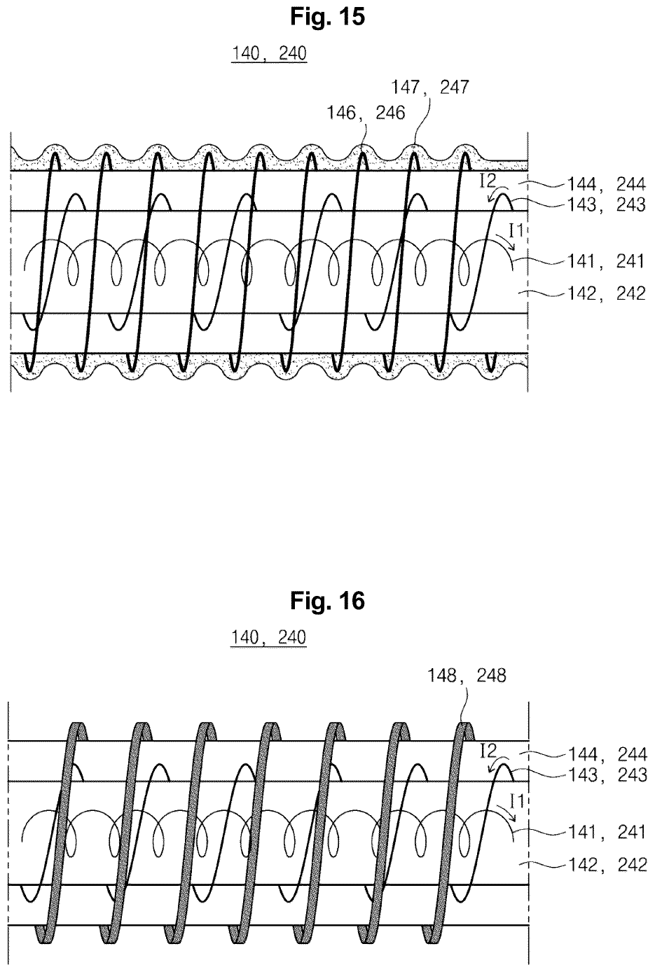

FIG. 15 is a view for describing a first heating wire and a second heating wire of a double earthing mat according to a sixth modified example of the present invention.

Referring to FIG. 15, a first heating wire 140 and a second heating wire 240 of a double earthing mat according to a sixth modified example of the present invention may further include coating layers 147 and 247, in addition to the first coils 141 and 241, the first insulating layers 142 and 242, the second coils 143 and 243, the second insulating layers 144 and 244, and the electromagnetic wave absorption parts 146 and 246 described with reference to FIG. 14.

The coating layers 147 and 247 may cover the electromagnetic wave absorption parts 146 and 246 in the form of metal wires. The coating layers 147 and 247 may be formed by coating the electromagnetic wave absorption parts 146 and 246 and the second insulating layers 144 and 244 therebetween with metal paste.

Compared to a case where the electromagnetic wave absorption parts 146 and 246 are provided as metal foils as shown in FIG. 13, when the electromagnetic wave absorption parts 146 and 246 are provided in the form of metal wires as shown in FIGS. 14 and 15, electromagnetic wave absorption efficiency may be reduced due to a narrow surface area.

However, when the coating layers 147 and 247 having thin thicknesses are provided on the electromagnetic wave absorption parts 146 and 246 as in the sixth modified example of the present invention, the electromagnetic waves that are transmitted without being absorbed due to narrow surface areas of the electromagnetic wave absorption parts 146 and 246 in the form of metal wires may be easily absorbed and blocked by the coating layers 147 and 247.

FIG. 16 is a view for describing a first heating wire and a second heating wire of a double earthing mat according to a seventh modified example of the present invention.

Referring to FIG. 16, a first heating wire 140 and a second heating wire 240 of a double earthing mat according to a seventh modified example of the present invention may include electromagnetic wave absorption parts 148 and 248 in the form of lines, in addition to the first coils 141 and 241, the first insulating layers 142 and 242, the second coils 143 and 243, and the second insulating layers 144 and 244 described with reference to FIG. 13.

Unlike the configuration described with reference to FIGS. 13 to 15, the electromagnetic wave absorption parts 148 and 248 may be provided in the form of metal ribbons. In addition, the electromagnetic wave absorption parts 148 and 248 may be provided in the form of coils that surround the second insulating layers 144 and 244.

Accordingly, even when the double earthing mat including a heat supply pipe according to the seventh modified example is folded or subjected to physical stress by a user, the double earthing mat may be prevented from being deformed or damaged, and electromagnetic wave absorption efficiency may be improved due to a large surface area.

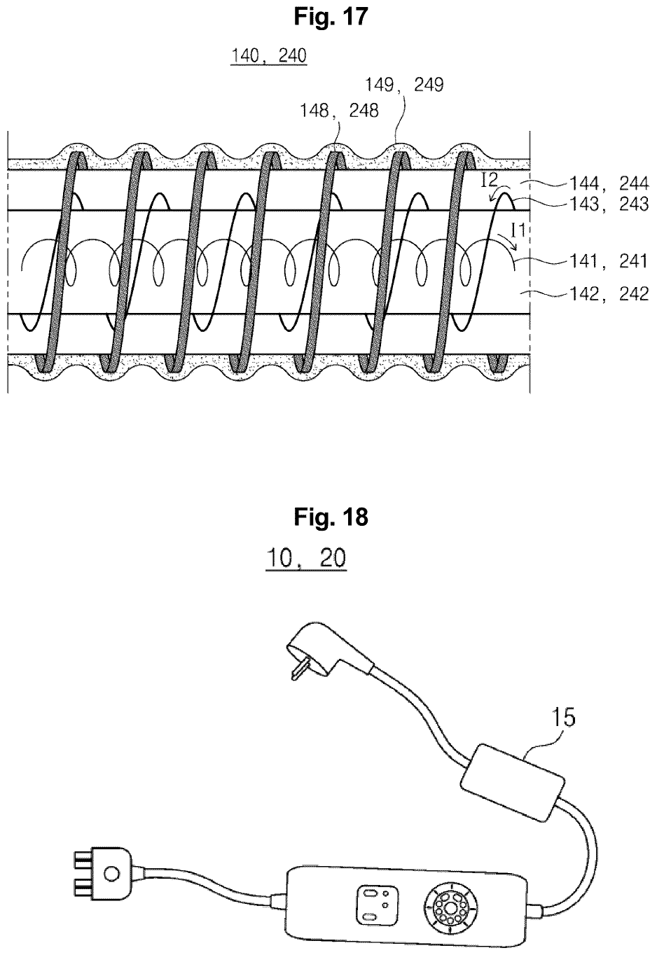

FIG. 17 is a view for describing a first heating wire and a second heating wire of a double earthing mat according to an eighth modified example of the present invention.

Referring to FIG. 17, a first heating wire 140 and a second heating wire 240 of a double earthing mat according to an eighth modified example of the present invention may further include coating layers 149 and 249, in addition to the first coils 141 and 241, the first insulating layers 142 and 242, the second coils 143 and 243, the second insulating layers 144 and 244, and the electromagnetic wave absorption parts 148 and 248 described with reference to FIG. 16.

The coating layers 149 and 249 may cover the electromagnetic wave absorption parts 148 and 248 in the form of metal ribbons. The coating layers 149 and 249 may be formed by coating the electromagnetic wave absorption parts 148 and 248 and the second insulating layers 144 and 244 therebetween with metal paste.

FIG. 18 is a view for describing a controller for a double earthing mat according to a ninth modified example of the present invention.

Referring to FIG. 18, each of controllers 10 and 20, which are defined as a first controller 10 and/or a second controller 20 of a double earthing mat according to a ninth modified example of the present invention, may include a direct current power supply device 15.

The direct current power supply device 15 may convert a supplied current to achieve a voltage, a current, a frequency, and the like that are necessary to drive the first main body 100 and/or the second main body 200, and supply the converted current to the first main body 100 and/or the second main body 200. The direct current power supply device 15 may be an adapter or a switching mode power supply (SMPS), but is not limited thereto.

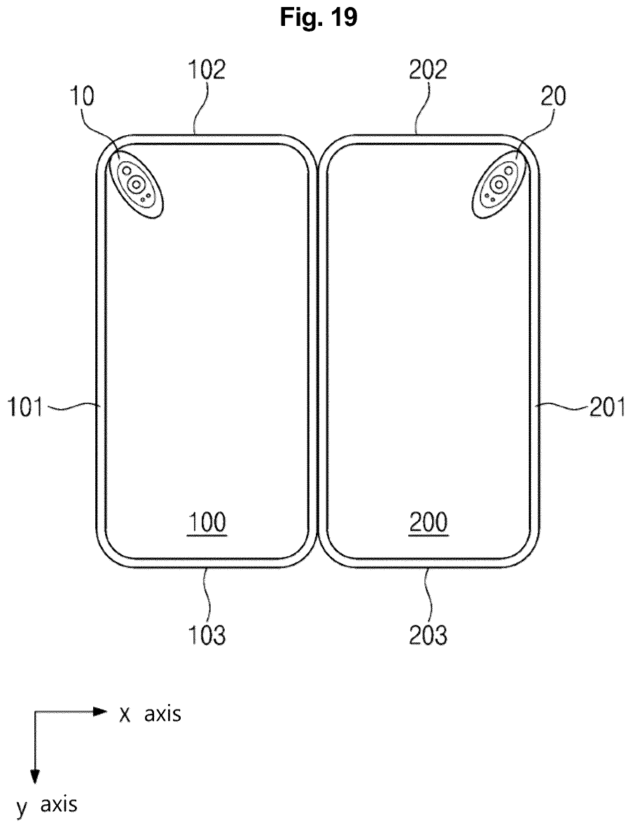

FIG. 19 is a view for describing a controller for a double earthing mat according to a 10th modified example of the present invention.

Referring to FIG. 19, a first controller 10 of a double earthing mat according to a 10th modified example of the present invention may be formed integrally with a first main body 100, and a second controller 20 of the double earthing mat may be formed integrally with a second main body 200. In more detail, the first controller 1 may be embedded in the first main body 100, or attached to an outside of the first main body 100. Similarly, the second controller 20 may be embedded in the second main body 200, or attached to an outside of the second controller 20.

In other words, the first controller 10 and the second controller 20 may be formed integrally with the double earthing mat. Accordingly, during storage, the first controller 10 and the second controller 20 may be stored together without being separated from the first main body 100 and the second main body 100. In addition, during use, there is no need to connect the first controller 10 and the second controller 20 to the first main body 100 and the second main body 100, so that convenience of storage and movement may be improved.

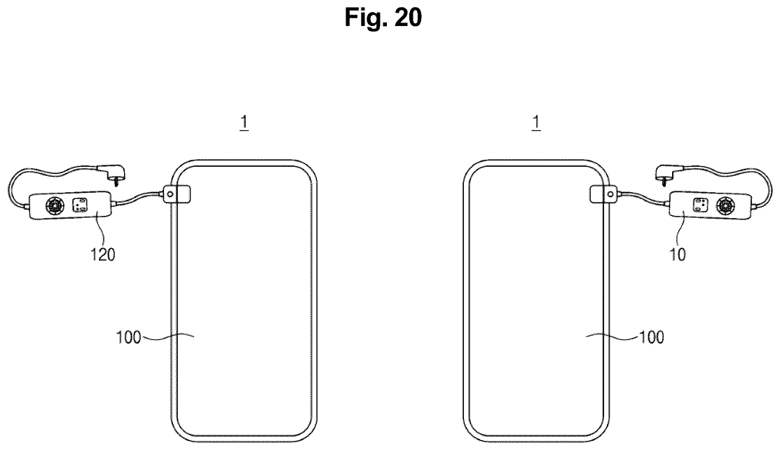

FIG. 20 is a view for describing a single earthing mat according to an 11th modified example of the present invention. Referring to FIG. 20, a first mat and a second mat according to an 11th modified example of the present invention may be independently configured. In other words, a single earthing mat 1 including the first mat and the second mat may be provided.

The single earthing mat 1 may include the first mat and the second mat, which are independently configured as described above. Although not shown in the drawing, the first mat and the second mat may be coupled to each other by a coupling member that is included. The coupling member may include at least one of Velcro, a zipper, and a snap button, but is not limited thereto. In other words, two single earthing mats 1 may be coupled to each other through the coupling member so as to be used as a double earthing mat for two people. That is, a plurality of single earthing mats 1 may be simply coupled to each other through the coupling member so as to be utilized as an earthing mat for multiple people, which may be used by multiple people, so that convenience of a user may be improved.

The single earthing mat 1 may include: a main body 100 in which a heating wire is disposed; and a controller 10 electrically connected to the heating wire, and configured to control a heating level of the heating wire.

Since the main body 100 is substantially identical to the first main body 100 shown in the embodiment of the present invention, detailed descriptions thereof will be omitted.

The controller 10 may include an energy conversion unit 170 for converting electromagnetic waves generated inside and/or outside the controller 10 into electric energy.

Since the energy conversion unit 170 is substantially identical to the energy conversion units 170 and 270 for converting electromagnetic waves generated inside and/or outside the first controller 10 into electric energy shown in the embodiment of the present invention and FIG. 6, detailed descriptions thereof will be omitted.

Although not shown in the drawing, according to one embodiment, each of a first controller 10 and a second controller 20 may include a solar cell and a battery. Accordingly, the battery may be charged by using the solar cell other than electricity, so that the double earthing mat may be used even in situations where supply of the electricity is difficult.

Alternatively, according to another embodiment, the first controller 10 and the second controller 20 may receive power through a cigarette lighter socket, a USB port, or the like. Accordingly, the double earthing mat may receive power from various power sources so as to be used.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

### INDUSTRIAL APPLICABILITY

The present invention may be utilized as a double earthing mat for two people, in which a first main body in which a first heating wire is disposed and a second main body in which a second heating wire is disposed are formed integrally with each other, and a first controller and a second controller are independently provided so as to be controlled independently of each other according to an embodiment of the present disclosure.

1. A double earthing mat in which a first mat and a second mat are formed integrally with each other, wherein the first mat includes:
a first main body in which a first heating wire is disposed; and
a first controller electrically connected to the first heating wire, and configured to control a heating level of the first heating wire, and
the second mat includes:
a second main body in which a second heating wire is disposed; and
a second controller electrically connected to the second heating wire, and configured to control a heating level of the second heating wire and operate independently of the first controller.

2. The double earthing mat of claim 1, wherein the first main body includes:
a first-first side surface, which is a long side surface of the first main body;
a first-second side surface, which is a short side surface of the first main body perpendicular to the first-first side surface; and
a first-third side surface, which is a short side surface of the first main body opposite to the first-second side surface,
the second main body includes:
a second-first side surface, which is a long side surface of the second main body opposite to the first-first side surface;
a second-second side surface, which is a short side surface of the second main body extending from the first-second side surface; and
a second-third side surface, which is a short side surface of the second main body extending from the first-third side surface,
a folding part that is bent so as to allow the first main body and the second main body to overlap each other is provided between the first main body and the second main body,
the first controller is coupled onto the first-first side surface that is adjacent to the first-second side surface,
the second controller is coupled onto the second-first side surface that is adjacent to the second-second side surface,
one end and an opposite end of the first heating wire are electrically connected to the first controller,
one end and an opposite end of the second heating wire are electrically connected to the second controller,
the first heating wire includes:
a first-first heating wire part having one end connected to the first controller, and extending parallel to the first-second side surface in a first direction toward the folding part from the first-first side surface;
a first-second heating wire part connected to an opposite end of the first-first heating wire part, parallel to the first-first side surface, and extending in a second direction toward the first-third side surface from the first-second side surface;
a plurality of first-third heating wire parts extending in the first direction, and spaced apart from each other in the second direction; and
a plurality of first-fourth heating wire parts, in which each of the first-fourth heating wire parts connects one end and an opposite end of adjacent first-third heating wire parts,
the first-third heating wire part includes:
a lowermost first-third heating wire part having one end connected to an opposite end of the first-second heating wire part, and disposed closest to the first-third side surface;
an uppermost first-third heating wire part having one end electrically connected to the first controller, and disposed closest to the first-first heating wire part; and
an intermediate first-third heating wire part disposed between the lowermost first-third heating wire part and the uppermost first-third heating wire part,
the first-fourth heating wire part connects an opposite end of the lowermost first-third heating wire part to one end of the intermediate first-third heating wire part, and connects an opposite end of the intermediate first-third heating wire part to an opposite end of the uppermost first-third heating wire part,
a plurality of intermediate first-third heating wire parts are provided,
the first-fourth heating wire part connects one end of the intermediate first-third heating wire part to an opposite end of an adjacent intermediate first-third heating wire part,
the first-first heating wire part, the first-second heating wire part, the first-third heating wire part, and the first-fourth heating wire part are arranged so as not to overlap each other,
the second heating wire includes:
a second-first heating wire part having one end connected to the second controller, extending parallel to the second-second side surface in a direction that is antiparallel to the first direction, and provided in a shape that is mirror-symmetrical with the first-first heating wire part based on the folding part;
a second-second heating wire part connected to an opposite end of the second-first heating wire part, extending parallel to the second-first side surface in the second direction, and provided in a shape that is mirror-symmetrical with the first-second heating wire part based on the folding part;
a plurality of second-third heating wire parts extending in the first direction, spaced apart from each other in the second direction, and provided in a shape that is mirror-symmetrical with the first-third heating wire parts based on the folding part; and
a plurality of second-fourth heating wire parts, in which each of the second-fourth heating wire parts connects one end and an opposite end of adjacent second-third heating wire parts, and the second-fourth heating wire parts are provided in a shape that is mirror-symmetrical with the first-fourth heating wire parts based on the folding part, and
the first heating wire and the second heating wire do not traverse the folding part.

3. The double earthing mat of claim 1, wherein the first main body includes:
a first-first side surface, which is a long side surface of the first main body;
a first-second side surface, which is a short side surface of the first main body perpendicular to the first-first side surface; and
a first-third side surface, which is a short side surface of the first main body opposite to the first-second side surface,
the second main body includes:
a second-first side surface, which is a long side surface of the second main body opposite to the first-first side surface;
a second-second side surface, which is a short side surface of the second main body extending from the first-second side surface; and
a second-third side surface, which is a short side surface of the second main body extending from the first-third side surface,
a folding part that is bent so as to allow the first main body and the second main body to overlap each other is provided between the first main body and the second main body,
the first controller is coupled onto the first-second side surface that is adjacent to the folding part,
the second controller is coupled onto the second-second side surface that is adjacent to the second-first side surface,
one end and an opposite end of the first heating wire are electrically connected to the first controller,
one end and an opposite end of the second heating wire are electrically connected to the second controller,
the first heating wire includes:
a first-first heating wire part having one end connected to the first controller, and extending parallel to the folding part in a second direction toward the first-third side surface from the first-second side surface;
a first-second heating wire part connected to an opposite end of the first-first heating wire part, parallel to the first-third side surface, and extending in a direction that is antiparallel to a first direction toward the folding part from the first-first side surface;
a plurality of first-third heating wire parts extending in the second direction, and spaced apart from each other in the first direction; and
a plurality of first-fourth heating wire parts, in which each of the first-fourth heating wire parts connects one end and an opposite end of adjacent first-third heating wire parts,
the first-third heating wire part includes:
an innermost first-third heating wire part having one end connected to an opposite end of the first-second heating wire part, and disposed closest to the folding part;
an outermost first-third heating wire part having one end electrically connected to the first controller, and disposed closest to the first-first heating wire part; and
an intermediate first-third heating wire part disposed between the innermost first-third heating wire part and the outermost first-third heating wire part,
the first-fourth heating wire part connects an opposite end of the innermost first-third heating wire part to one end of the intermediate first-third heating wire part, and connects an opposite end of the intermediate first-third heating wire part to an opposite end of the outermost first-third heating wire part,
the first-first heating wire part, the first-second heating wire part, the first-third heating wire part, and the first-fourth heating wire part are arranged so as not to overlap each other,
the second heating wire includes:
a second-first heating wire part having one end connected to the second controller, and extending parallel to the second-first side surface in the second direction;
a second-second heating wire part connected to an opposite end of the second-first heating wire part, parallel to the second-third side surface, and extending in the direction that is antiparallel to the first direction;
a plurality of second-third heating wire parts extending in the second direction, and spaced apart from each other in the first direction; and
a plurality of second-fourth heating wire parts, in which each of the second-fourth heating wire parts connects one end and an opposite end of adjacent second-third heating wire parts,
the second-third heating wire part includes:
an innermost second-third heating wire part having one end connected to an opposite end of the second-second heating wire part, and disposed closest to the folding part;
an outermost second-third heating wire part having one end electrically connected to the second controller, and disposed closest to the second-first heating wire part; and
an intermediate second-third heating wire part disposed between the innermost second-third heating wire part and the outermost second-third heating wire part,
the second-fourth heating wire part connects an opposite end of the innermost second-third heating wire part to one end of the intermediate second-third heating wire part, and connects an opposite end of the intermediate second-third heating wire part to an opposite end of the outermost second-third heating wire part,
the second-first heating wire part, the second-second heating wire part, the second-third heating wire part, and the second-fourth heating wire part are arranged so as not to overlap each other, and
the first heating wire and the second heating wire do not traverse the folding part.

4. The double earthing mat of claim 1, wherein the first main body includes:
a first-first side surface, which is a long side surface of the first main body;
a first-second side surface, which is a short side surface of the first main body perpendicular to the first-first side surface; and
a first-third side surface, which is a short side surface of the first main body opposite to the first-second side surface,
the second main body includes:
a second-first side surface, which is a long side surface of the second main body opposite to the first-first side surface;
a second-second side surface, which is a short side surface of the second main body extending from the first-second side surface; and
a second-third side surface, which is a short side surface of the second main body extending from the first-third side surface,
a folding part that is bent so as to allow the first main body and the second main body to overlap each other is provided between the first main body and the second main body,
the first controller is coupled onto the first-second side surface that is adjacent to the first-first side surface,
the second controller is coupled onto the second-second side surface that is adjacent to the second-first side surface,
one end and an opposite end of the first heating wire are electrically connected to the first controller,
one end and an opposite end of the second heating wire are electrically connected to the second controller,
the first heating wire includes:
a first-first heating wire part having one end connected to the first controller, and extending parallel to the first-first side surface in a second direction toward the first-third side surface from the first-second side surface;
a first-second heating wire part connected to an opposite end of the first-first heating wire part, parallel to the first-third side surface, and extending in a first direction toward the folding part from the first-first side surface;
a plurality of first-third heating wire parts extending in the second direction, and spaced apart from each other in the first direction; and
a plurality of first-fourth heating wire parts, in which each of the first-fourth heating wire parts connects one end and an opposite end of adjacent first-third heating wire parts,
the first-third heating wire part includes:
an innermost first-third heating wire part having one end connected to an opposite end of the first-second heating wire part, and disposed closest to the folding part;
an outermost first-third heating wire part having one end electrically connected to the first controller, and disposed closest to the first-first heating wire part; and
an intermediate first-third heating wire part disposed between the innermost first-third heating wire part and the outermost first-third heating wire part,
the first-fourth heating wire part connects an opposite end of the innermost first-third heating wire part to one end of the intermediate first-third heating wire part, and connects an opposite end of the intermediate first-third heating wire part to an opposite end of the outermost first-third heating wire part,
the first-first heating wire part, the first-second heating wire part, the first-third heating wire part, and the first-fourth heating wire part are arranged so as not to overlap each other,
the second heating wire includes:
a second-first heating wire part having one end connected to the second controller, extending parallel to the second-first side surface in the second direction, and provided in a shape that is mirror-symmetrical with the first-first heating wire part based on the folding part;
a second-second heating wire part connected to an opposite end of the second-first heating wire part, parallel to the second-third side surface, extending in a direction that is antiparallel to the first direction, and provided in a shape that is mirror-symmetrical with the first-second heating wire part based on the folding part;
a plurality of second-third heating wire parts extending in the second direction, spaced apart from each other in the first direction, and provided in a shape that is mirror-symmetrical with the first-third heating wire parts based on the folding part; and
a plurality of second-fourth heating wire parts, in which each of the second-fourth heating wire parts connects one end and an opposite end of adjacent second-third heating wire parts, and the second-fourth heating wire parts are provided in a shape that is mirror-symmetrical with the first-fourth heating wire parts based on the folding part, and
the first heating wire and the second heating wire do not traverse the folding part.

5. The double earthing mat of claim 1, wherein the first main body includes:
a first-first side surface, which is a long side surface of the first main body;
a first-second side surface, which is a short side surface of the first main body perpendicular to the first-first side surface; and
a first-third side surface, which is a short side surface of the first main body opposite to the first-second side surface,
the second main body includes:
a second-first side surface, which is a long side surface of the second main body opposite to the first-first side surface;
a second-second side surface, which is a short side surface of the second main body extending from the first-second side surface; and
a second-third side surface, which is a short side surface of the second main body extending from the first-third side surface,
a folding part that is bent so as to allow the first main body and the second main body to overlap each other is provided between the first main body and the second main body,
the first controller is coupled onto the first-second side surface that is adjacent to the first-first side surface,
the second controller is coupled onto the second-second side surface that is adjacent to the folding part,
one end and an opposite end of the first heating wire are electrically connected to the first controller,
one end and an opposite end of the second heating wire are electrically connected to the second controller,
the first heating wire includes:
a first-first heating wire part having one end connected to the first controller, and extending parallel to the first-first side surface in a second direction toward the first-third side surface from the first-second side surface;
a first-second heating wire part connected to an opposite end of the first-first heating wire part, parallel to the first-third side surface, and extending in a direction that is antiparallel to a first direction toward the first-first side surface from the folding part;
a plurality of first-third heating wire parts extending in the second direction, and spaced apart from each other in the first direction; and
a plurality of first-fourth heating wire parts, in which each of the first-fourth heating wire parts connects one end and an opposite end of adjacent first-third heating wire parts,
the first-third heating wire part includes:
an innermost first-third heating wire part having one end connected to an opposite end of the first-second heating wire part, and disposed closest to the folding part;
an outermost first-third heating wire part having one end electrically connected to the first controller, and disposed closest to the first-first heating wire part; and
an intermediate first-third heating wire part disposed between the innermost first-third heating wire part and the outermost first-third heating wire part,
the first-fourth heating wire part connects an opposite end of the innermost first-third heating wire part to one end of the intermediate first-third heating wire part, and connects an opposite end of the intermediate first-third heating wire part to an opposite end of the outermost first-third heating wire part,
the first-first heating wire part, the first-second heating wire part, the first-third heating wire part, and the first-fourth heating wire part are arranged so as not to overlap each other,
the second heating wire includes:
a second-first heating wire part having one end connected to the second controller, and extending parallel to the folding part in the second direction;
a second-second heating wire part connected to an opposite end of the second-first heating wire part, parallel to the second-third side surface, and extending in the first direction;
a plurality of second-third heating wire parts extending in the second direction, and spaced apart from each other in the first direction; and
a plurality of second-fourth heating wire parts, in which each of the second-fourth heating wire parts connects one end and an opposite end of adjacent second-third heating wire parts,
the second-third heating wire part includes:
an outermost second-third heating wire part having one end connected to an opposite end of the second-second heating wire part, and disposed closest to the second-first side surface;
an innermost second-third heating wire part having one end electrically connected to the second controller, and disposed closest to the second-first heating wire part; and
an intermediate second-third heating wire part disposed between the outermost second-third heating wire part and the innermost second-third heating wire part,
the second-fourth heating wire part connects an opposite end of the outermost second-third heating wire part to one end of the intermediate second-third heating wire part, and connects an opposite end of the intermediate second-third heating wire part to an opposite end of the innermost second-third heating wire part,
the second-first heating wire part, the second-second heating wire part, the second-third heating wire part, and the second-fourth heating wire part are arranged so as not to overlap each other, and
the first heating wire and the second heating wire do not traverse the folding part.

6. The double earthing mat of claim 1, wherein the first controller is formed integrally with the first main body, and
the second controller is formed integrally with the second main body.

7. A single earthing mat in which single earthing mats include a first mat and a second mat, respectively, wherein each of the first mat and the second mat includes:
a main body in which a heating wire is disposed; and
a controller electrically connected to the heating wire, and configured to control a heating level of the heating wire,
the controller includes an energy conversion unit for converting electromagnetic waves generated inside and outside the controller into electric energy, and
the energy conversion unit includes:
a conversion unit for generating a surface current by using the electromagnetic waves;
a rectification unit for rectifying the surface current generated by the conversion unit; and
an energy storage unit for storing an alternating current rectified by the rectification unit in a form of the electric energy.

8. The single earthing mat of claim 7, wherein the first mat and the second mat are coupled to each other by a coupling member that is included, and
the coupling member includes at least one of Velcro, a zipper, and a snap button.
